(19) United States
(12) Patent Application Publication
(10) Pub. No.: US 2013/0304486 A1
(43) Pub. Date: Nov. 14, 2013

(54) SYSTEM, METHODS, AND COMPUTER READABLE-MEDIUM PROVIDING PAYMENT ACCOUNTS FOR HEALTHCARE RELATED SECURE REGISTRY

(71) Applicants: Paula L. Jagemann, Frederick, MD (US); Andrew Z. Schiff, Silver Spring, MD (US); Darren M. McCue, Gaithersburg, MD (US)

(72) Inventors: Paula L. Jagemann, Frederick, MD (US); Andrew Z. Schiff, Silver Spring, MD (US); Darren M. McCue, Gaithersburg, MD (US)

(73) Assignee: Someone With, LLC, Frederick, MD (US)

(21) Appl. No.: 13/865,609

(22) Filed: Apr. 18, 2013

Related U.S. Application Data
(63) Continuation-in-part of application No. PCT/US2011/056955, filed on Oct. 19, 2011.
Application No. PCT/US2011/056955 is a continuation-in-part of application No. 13/092,668, filed on Apr. 22, 2011.
(60) Provisional application No. 61/394,550, filed on Oct. 19, 2010.
(60) Provisional application No. 61/327,555, filed on Apr. 23, 2010.
(60) Provisional application No. 61/394,550, filed on Oct. 19, 2010.
(60) Provisional application No. 61/447,381, filed on Feb. 28, 2011.

(51) Int. Cl. G06F 19/00; G06Q 50/00

(52) U.S. Cl. CPC G06F 19/328; G06Q 50/01
USPC 705/2

(57) ABSTRACT

A computer-implemented method, apparatus, and system for providing an ability to contribute towards specific items may be provided. A consumer account may be created for a consumer and managed by a consumer account management system. A contribution to the consumer account may be received from a benefactor. Rules may be applied designating a purchase of specialty items which may be relevant to a particular disease or disorder at a given stage or treatment cycle of the disease or disorder. The specialty items may be associated with vendor systems. The benefactor's contribution may be credited to the consumer account. Sales transaction data and financial data may be received. Data regarding the specialty items, consumers, vendor systems, sales transactions, and the disease or disorder may be stored.

### CROSS-REFERENCE TO RELATED APPLICATIONS

This application is a continuation-in-part of copending International Patent Application PCT/US2011/056955, with an international filing date of Oct. 19, 2011, which is a continuation-in-part of U.S. patent application Ser. No. 13/092,668 filed on Apr. 22, 2011, which claims the benefit of U.S. Provisional Application No. 61/327,555, filed Apr. 23, 2010, U.S. Provisional Application No. 61/394,550, filed Oct. 19, 2010, and U.S. Provisional Application No. 61/447,381, filed Feb. 28, 2011. International Patent Application PCT/US2011/056955, U.S. patent application Ser. No. 13/092,668 and U.S. Provisional Patent Application Nos. 61/327,555, 61/394,550, and 61/447,381 are hereby incorporated by reference in their entirety.

### BACKGROUND

1. Field of Invention

Embodiments of the present invention relate generally to ecommerce, and more particularly to a communication system designed to coordinate available funds with elected products and services.

2. Background

The current healthcare system has been governed the same way for many years. Minor modifications have been made to push more costs to the individual. Despite the revolution of social media, the ability to quickly communicate with third parties about needs, and the current inability to monitor financial contributions made in the spirit of aiding a “medical crisis” are all outdated. The failure points are many. Fraud is rampant.

### SUMMARY

Aspects of the invention may provide systems, methods, and computer readable medium for establishing a digital health care currency, managing the crediting and debiting of the currency, and monitoring the digital currency flow. In particular aspects of the invention, computer accounts are established for numerous consumers, each of whom has a need for products and services relevant to a health condition. Digital currency in the form of money or other forms of currency (coupons, in-kind donations) can be credited to an individual account from various sources. Each consumer account tracks the amount and kind of currency credited to that account, and the currency debited from the account, along with various types of associated data. Currency can be provided by friends, family, and non-profits selected by the individual consumer. Further, corporate donors may provide currency to be credited to a group of individual accounts. Also, governments and insurance companies may provide digital currency to particular accounts, and the consumer may add funds to his or her account as well. For each type of currency, associated data includes designations of particular products or services, or types of products or services, or vendors of products or services for which the currency may be spent. The system matches the designation rules for each type of currency with purchase choices by the consumer and allows for currency to be debited from the account if it is designated for a particular purchase, and rejects debiting the account if the purchase is not in a designated class of purchases. For example, designation rules may permit purchasing any product or service from a particular vendor's catalog of items relevant to the consumer's health condition. Rules may permit payment for purchasing prescription drugs or co-pays or fees associated with medical procedures. Some currency within the system may be nondesignated and unrestricted. But in any event each account is set up with some kind of relevance limitations so that each amount of currency credited to the account can be designated so that it can only be debited for items having some relevance to a health condition of the account holder.

In an embodiment of the invention, a computer implemented method for payment of healthcare related items may be provided. The method may include, for example, creating a consumer account for a consumer, where the consumer account may be managed by a consumer account management system; a contribution may be received into the consumer account from a benefactor, where the benefactor may be a friend, acquaintance, or family member of the consumer, a non-profit organization, or a corporation wherein the contribution may not be associated with insurance of the consumer; rules may be applied designating as approved for purchase specialty items relevant to a particular disease or disorder at a given stage or treatment cycle of the disease or disorder, where the specialty items may be associated with vendor systems, where the vendor systems may be integrated with the consumer account management system or may be third-party vendor systems; contribution may be credited to the consumer account; data on sales transactions may be received for the specialty items; and relational data regarding the specialty items, consumers, vendor systems, sales transactions, and/or the disease or disorder may be stored.

In an embodiment of the invention, computer-readable storage media may be provided that may contain instructions executable by processing logic. The media may store instructions for performing the following operations creating a consumer account associated with a consumer; adding a consumer-selected item to the consumer account; receiving funds directed to the consumer account from a benefactor, where the benefactor may include at least one of: a friend, a family member, a charity, a manufacturer, or a third-party; associating the funds with rules from the benefactor, where the rules designate categories of items that may be purchased; receiving purchase data of an item designated in accordance with the rules from the benefactor, where purchase data includes data on at least one of: items purchased or items rejected for non-compliance with the rules from the benefactor; and consolidating purchase data across multiple retail outlets.

In another embodiment of the invention, a consumer account management system may be provided. The consumer account management system may include, for example, a consumer account creation module for creating a consumer account associated with a consumer; a contribution receiving module for receiving a contribution directed to the consumer account from a benefactor and crediting the contribution to the consumer account, where the benefactor may be a friend, acquaintance, or family member of the consumer, a non-profit organization, or a corporation wherein the contribution may not be associated with insurance of the consumer; a benefactor rules module for associating the contribution with rules from the benefactor, where the rules may designate as approved for purchase a purchase specialty items relevant to a particular disease or disorder at a given stage or treatment cycle of the disease or disorder; a purchase data receiving module for receiving purchase data of the specialty items, where the items may have been purchased by the consumer in accordance to the rules from the benefactor; and a database for storing data on at least one of: purchases, the one or more specialty items, consumers, sales transactions, and/or the disease or disorder.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an illustrative high-level flow diagram for use with an example embodiment for providing payment accounts;

FIG. 2 depicts an illustrative home webpage illustrating an example embodiment for providing payment accounts;

FIG. 3 depicts an illustrative registry page illustrating an example embodiment for providing payment accounts;

FIG. 4 depicts an illustrative consumer workflow for use with an example embodiment for providing payment accounts;

FIG. 5 depicts an illustrative process flow diagram for use with an example embodiment for providing payment accounts;

FIG. 6 depicts an illustrative currency model for use with an example embodiment for providing payment accounts;

FIG. 7 depicts an illustrative data monetization model for use with an example embodiment for providing payment accounts;

FIG. 8 depicts an illustrative registry page for a contributor for use with an example embodiment for providing payment accounts;

FIG. 9 depicts an illustrative monetary contribution page for use with an example embodiment for providing payment accounts;

FIG. 10 depicts an illustrative shopping cart for use with an example embodiment for providing payment accounts;

FIG. 11 depicts an illustrative checkout options page for use with an example embodiment for providing payment accounts;

FIG. 12 depicts an illustrative workflow for use with an example method of providing payment accounts;

FIG. 13 depicts an illustrative contributor workflow for use with an example embodiment for providing payment accounts;

FIG. 14 depicts an illustrative computer system for use with an example embodiment for providing payment accounts;

FIG. 15 depicts an illustrative network for use with an example embodiment for providing payment accounts;

FIG. 16 depicts an illustrative high-level system flow diagram for use with an example embodiment for providing payment accounts;

FIG. 17 depicts an illustrative workflow displaying an example dynamic assessment; and

FIG. 18 depicts an example care plan.

### DETAILED DESCRIPTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

Introduction

One embodiment of this invention may help individuals with diseases and/or disorders (e.g., breast cancer, prostate cancer, lupus, arthritis, heart disease, autism, multiple sclerosis, sleep disorders, migraines, etc.) by combining and providing ecommerce and social media tools, for example, to ease the personal and financial burden of disease management. The current state of the art does not provide for the ability to conveniently purchase quality home health and medical supplies while observing the Health Insurance Portability and Accountability Act of 1996 (HIPAA). Furthermore, the current state of the art may not provide a robust resource for home health and/or medical supplies which leaves a significant number of first time buyers spending an great deal of time searching for unfamiliar—often-expensive—products with little guidance and overwhelming financial burden.

One embodiment of the invention may include the technology to provide an online and print specialty product catalog specifically created to support the consumer experience by streamlining processes related to product identification, sourcing, and shipping, directly related to or in coordination with an individual's medical course of treatment in chronic or catastrophic disease management. This includes pre-, during- and post-treatment product selection support as well as product satisfaction ratings and crowd-sourced product identification/selection/retention. In addition, an embodiment may offer novel financial solutions to combat the financial burden that accompanies catastrophic or chronic disease management, such as cancer, diabetes, Parkinson's, Multiple Sclerosis, Autism, etc. One in ten people will encounter a “chronic” disease in their lifetime. An embodiment may provide specialty products that are otherwise difficult to find, while easing the financial burden associated with catastrophic or chronic disease management. One in ten people battling cancer, go bankrupt.

An embodiment of this invention may provide technology to include product identification, sourcing, and shipping in a compassionate and dignified manner while providing unique financial support. A consumer may spend hours, looking for unfamiliar and expensive categories of products, such as “drainage belts,” compression gauntlets, chemotherapy ready skin care products, etc. By applying tools for expert advice and research, an embodiment of this invention may provide product identification, often from small, niche and unsophisticated manufacturers. Few of the manufacturers of products for disease maintenance and wellbeing use professional distribution networks or wholesalers. Additionally, products may straddle health, beauty, and medicinal and, therefore, may not be easily categorized. For products that are not categorized as a medical necessity and are not “reimbursable,” the product availability tends to be limited and one can expect to spend hours researching and procuring the products and services. For patients or caregivers this time may be precious and should be spent managing their disease or spending time with loved ones.

Once products are identified an embodiment of this invention may source them from one location, so consumers can receive one beautifully, carefully packaged box and one receipt for streamlined medical/tax/personal record keeping for products which may have been screened by experts in their fields, and rated by others undergoing the same medical journey or procedures. A listing of the ingredients for the products may also be included. An embodiment of the invention may be committed to being the most relevant catalog to patients' during a medical crisis. Products that do not maintain a certain level of satisfaction may be pulled from the catalog, e-retail store, and inventory. Every activity will be self-governed by our consumers and experts in that category of care, which may provide consumers with unique feedback directly from other people who have had personal experience with the products and services.

Outside of product identification and sourcing, which could impact a medical crisis or other time-sensitive product and service needs, an embodiment of this invention may provide a novel mechanism to allow others to aid in a patient's expense stream, while honoring currently mandated medical privacy (e.g., HIPAA) protections. A “registry” may be created that, unlike existing bridal or baby registries, which are open to anyone, may be closed unless patients which/that wish to privately and securely invite individuals to view and contribute to their registry.

An embodiment of this invention may offer products that may be closely tied to disease and/or disorder management, such as breast or prostate cancers. Therefore, an open “registry” could lead to the unwanted disclosure of medical conditions. An embodiment of this invention may offer a way for any third parties to contribute to a patient's financial burden. In this instance, third parties are not just limited to friends and family, but may include any third party including public or private foundations and groups or entities that have missions that align with an individual's current time sensitive needs.

Contributions may come in the form of outright financial support as a dollar amount (for use towards, for example, products, services, co-pays, etc.), the procurement of a specific product or service, discounts, coupons, or offerings of free services or products. Additionally, entities, such as manufacturers and/or retailers, may provide coupons and/or sample products as a form of targeted advertising.

The ability to contribute towards a specific product or service may provide an opportunity for people (e.g., benefactors) and/or entities (e.g., foundations, charities, etc.) to provide financial support during a person's greatest time of need. Previously, people who wanted to support patients were relegated to buying flowers, balloons, books, or otherwise, sympathetic, but, unproductive gifts. The opportunity to pool financial resources and apply them to health and medical expenses may have a meaningful impact on patients' expenses.

Not only are physical products (that can be touched, boxed or shipped) offered but services and/or money for services may also be offered. Services may include co-pays and treatment options that may not be covered by reimbursement, such as, for example, complementary or alternative therapies sought outside of the course of traditional treatment (e.g., Reiki, acupuncture, nutrition counseling, exercise, meditation, medically oriented or spiritual healing journeys, etc). Additionally, in-kind services and items may also be provided (e.g., homemade meals, dog sitting, etc.).

Contributors may purchase specific items or services for the patient. These items may have been selected by the patient and placed on the registry or they could be items selected entirely by the contributor. The contributor may also provide an amount of funds to be used for the purchase of products or services. The contributor may allow the funds only to be used for the purchase of specific products or services (e.g., a wig). The contributor may also select a more general type of product or service (e.g., prescriptions). Thus, products that contributors want to contribute to help a patient manage during his/her time of need may be considered “fully restricted giving” or “fully designated giving” which may include, for example, designating items or services based on a merchant category code (MCC), an item code, a stock-keeping unit (SKU), a universal product code (UPC), a standard industrial classification (SIC), a North American industry classification system (NAICS), or a global industry classification standard (GICS). Alternatively, the contribution could be considered undesignated and the patient/consumer could use the funds for items of his or her choice.

Currently, HIPAA may restrict the receipt of payment from anyone outside of a patient's healthcare coverage plan (e.g., spouse, parents or children). Sorority sisters, co-workers, church groups, friends and extended family, for example, are relegated to giving funds directly to the individual in need. Once those funds are transferred it is up to “good faith” that they are used as intended for medical or illness related expenses. An embodiment of this invention may provide assurance that the gifts are used in the manner the contributor desires.

An embodiment of this invention may save time from scavenger hunting online and in brick and mortar stores for products and services that patients may need during their home health and medical care. Locating a product may be challenging, let alone vetting it for quality and price. Additionally required may be document management and reporting back to interested parties such as oncologists, radiologists and other care givers that need to be made aware of medical, health and or unrelated goods and services that may negatively impact a patient's well-being. This may occur at a time when time is precious and fighting for medical “reimbursement” may be not only consuming but stress inducing, this stress alone can negatively impact treatment, and recovery. One box, one receipt, with multiple copies to be provided to those who would aid in the knowledge of these goods, including expense management, IRS reporting, medical record keeping, etc.

In addition to time savings, an embodiment of this invention may offer financial solutions that may help patients afford what they need or like during their course of treatment. Having products and services available may make it more likely that the patient will complete or be compliant with their treatment regimen. Third parties, such as friends and family, may have the ability to relieve patients from overwhelming financial burden, by contributing dollar amounts to specific goods and or services, such as chemotherapy or prescription drug co-pays or to a general contribution. A “medical” registry and/or a portable “registry” may be provided such that patients may take to healthcare, retail and other paid for service or goods providers. Contributors can specify their desired use of proceeds, ensuring that their gifts are used in the manner in which they were given. An embodiment of this invention may be a combination of social media, flexible spending and web integration to existing FSAs to allow for only employee or government sponsored participation, or self-payment.

In one embodiment, to negate the need for self-funding and/or co-pays, a patient/consumer may be provided with a flexible mechanism, such as, for example a card, which may be acceptable by commercially viable entities (e.g., websites, pharmacies, etc.) and which may be pre-paid or pre-funded by third parties (e.g., benefactors). The flexible mechanism may be tied into the patient registry. Contributions made into the registry may be associated with spending limits of the flexible mechanism.

With financial support a patient may increase the likelihood of compliance with his/her course of care, i.e., if they can pay for their medicinal needs, using third party funds, they may actually buy and use them to their restoration of health or in health maintenance. With enough financial support, rather than a patient abandoning chemotherapy or radiation in treatment month 15 of 20, for example, they may be able to complete their course of care. The likelihood of them returning to the system, in worse medical condition, months or years later, may be negated. Not only may a burden be taken off of the financial system, but the healthcare system as well.

In one embodiment of the invention, a goal may be to give time back to individuals with an illness. In one embodiment, the invention may remove guesswork out of a search process by aggregating “best in class” products and services to provide an extensive, but consolidated collection. Another goal may be to streamline the selection process. Products and services may be bundled by treatment type, reducing typical searches from, for example, 5 hours to less than 30 minutes. In another embodiment, ecommerce solutions (e.g., electronic shopping cart) may be integrated and may be created by a patient and reviewed by a professional, a doctor, a nurse, a patient navigator, a healthcare provider etc. and managed throughout the course of treatment, as well as a locator tool for finding specialists (e.g., certified mammography centers, licensed prosthesis fitters, nutritionists and other local specialists) to enable consumers to find reputable related services.

There may be strength in numbers and no one may know better than individuals who have used the products and services. Various disease communities may be known for support. An embodiment of this invention, may apply the community model to support individuals as they go through their journey with their particular illness. In one embodiment, the supplied community may be a multi-platform network, creating additional connections with and between consumers.

A ratings system may be implemented, which may be a first for this category of care. Products and services, such as fitters, may be reviewed, rated and shared by patients and their caregivers, for example. Products may be supplied to complement, not conflict with a patient's course of treatment.

In another embodiment, a registry may be provided. Consumers may select needed and/or wanted products (e.g., home medical supplies) and services. Third-parties such as family, friends, community groups, foundations, product manufacturers, suppliers, etc., may purchase products and services from the registry and may generate financial support in lieu of books or flowers, etc, thereby funneling money from sympathetic yet unproductive gifts. Once a registry is created, a social media campaign (e.g., to notify family, friends, and groups) may be created on the consumer's behalf to help raise contributions and fund mounting out-of-pocket expenses. As described above, funds may also be contributed into the registry allowing for the patient to use a flexible mechanism to purchase those items using the contributed funds.

In an exemplary embodiment of the invention, one purpose may be to direct people who genuinely ask and want help to bridge the gap between what you need and what you want (e.g. a $3,000 human hair wig). A consumer, for example, may be diagnosed with a disease or disorder. The consumer may wish to purchase or have purchased one or more specialty products and/or services designed to increase the quality of life for the consumer. These products and services may be selected from a comprehensive catalog of relevant products and services related to the consumer's need associated with a particular disease or disorder faced by the consumer at a particular stage or treatment cycle of the disease or disorder. In other words, the offered products and services may be targeted towards individuals with a particular need. The offered products and services may change as the individual's needs change over time as treatment or the illness progresses. Such a service may significantly reduce the amount of effort and time required by individuals with needs to find products and services that may enhance their quality of life.

Supplied services may also align free or complementary services (e.g., maid services) which may be offered by companies to those with particular disease or disorder. Requesting free services may be cumbersome and tedious with multiple forms and applications to complete. In one embodiment of this invention, the system may assist in completing requests for these services by assembling the required forms and the system may automatically insert information known by the system into the forms. In another embodiment, the system may match individuals with particular needs with individuals or entities that wish to contribute (e.g., national or local not-for-profits or foundations, dog walkers, hair for wigs, wig makers, quilts, etc.). The system may also match qualified consumers with services that may fit the consumer's particular needs. For example, the system may provide matching for consumers with low or no insurance with companies and groups that may provide free products or services (e.g., Avon may give free mammograms for individuals with low or no insurance). In other words, the system may be able to coordinate foundations with individuals who qualify for a grant, an entirely manual and tedious process today.

Family and friends may offer support for pre, during and post treatment cycles, and other organizations, foundations and entities may also offer support. Free and/or discounted services may exist for those battling cancer and other diseases or disorders. For example, at the current time, free wigs, breast prosthesis, and medication co-pay assistance are offered by the American Cancer Society and Cancer Care. Network of Strength offers a wig and prosthesis bank, The Red Devils offer local house cleaning, transportation to and from doctor appointments, and meal preparation, Mfeast offers free meals and nutritional advice for breast cancer and AIDS patients and survivors, Sirens for Survivors offers free professional photography sittings around the country. INK-B-GONE offers a program to help breast cancer survivors remove skin colorations left by radiation and chemotherapy. Lastly, many hotels and travel destinations offer discounts for free services for individuals suffering from diseases or disorders. These offered services, which will vary over time, are compassionate and valuable to each person they serve.

However, individuals suffering from a disease or disorder may have difficulty in finding these services. Additionally, once a service is found, the application may be tedious and may require constant monitoring. Each organization may have their own criteria for giving, their own applications and approval processes, and many are small organizations without high-tech approaches to submitting an application. For example, some organizations may require proof of your diseases or disorder in the form of a “letter of medical need,” financial information, and/or income information. These applications (i.e., “forms”) may be time consuming and often, when taken altogether, overwhelm consumers who may abandon their efforts in applying for such valuable services. The applications may cause additional frustration and confusion and may not guarantee the service or offering. In one embodiment, the invention may provide a type of pre-qualification for these services.

In an example embodiment of the invention, a consolidated manner in which to apply for services (e.g., free and discounted services) may be provided by pre-populating the consumer's selected application forms, all at once (e.g., autocomplete of the forms using stored or available information). Additionally, the application forms may be automatically identified based on the service selected. The paper application process may be made electronic for ease of filing. Fields on the forms may be populated with information drawn from stored consumer information. Fields may be highlighted where the information required cannot be located in the consumer's account, Information entered by the consumer may be saved for future use and applied to future applications if needed. Once the form is complete, the form may be filed with the entity. This may make it possible for consumers to apply for services, in volume, hassle-free.

An embodiment of the invention may provide a computer system, method, and/or computer-readable medium servicing needs of consumers with a particular disease and/or disorder, comprising some or all of the following components:
A comprehensive catalog of specialized cross-category products and services selected to meet the needs of consumers with the disease and/or disorder. The catalog may be a printed catalog or an on-line catalog. The catalog may be comprehensive in that it may include a broad spectrum of many different types of products and services (e.g., clothing, skin cream, bedding, massage, travel, real estate, etc.).
The catalog containing targeted products and services. The catalog may be targeted in that it may be directed towards meeting the needs of consumers with, for example, a particular disease and/or disorder at a given time, stage or treatment cycle of the disease or disorder. The needs of a consumer may include products and services required for personal health and/or wellbeing or in disease or multiple disease management. Wellbeing may include spiritual wellbeing or general contentment which may assist in disease management.
Items may include both products and services.
A plurality of secure personal registries containing products and services. A secure registry may mean the registries may be viewable only by the consumer and consumer identified third-parties. The consumer may select which third-parties can view the registry by sending an invitation to said third-party. An invitation may include a link (e.g., a URL) that may direct the third party to the consumer's secure registry. When the third-party clicks the link the third party may view the consumer's secure registry.
The healthcare products and services in the secure personal registries may be selected from the catalog by individual consumers. A consumer may select a product or service from the on-line catalog by clicking a button, a checkbox and/or an on-screen product image. When a product or multiples of a product are selected for the registry, it/they may appear in the consumer's registry until it is removed and/or purchased. The registry may include identifiers that are representations of the selected products and services.
The ability for experts and other third parties to recommend products and services for inclusion in the personal registry of one or more individual consumers.
The ability for third parties to contribute funds to a personal registry, with or without purchasing a product or service. Third parties may contribute a monetary amount into the registry as a general contribution or the monetary amount may be tied to the purchase of specific products or services.
The ability to manage the relationship between the catalog containing targeted products and services, recommenders, and consumers, while maintaining privacy of personal consumer data. Privacy of personal consumer data may be in compliance with federal and state rules and regulations requiring secure protection of personal and health information. Security may include prohibiting access to consumer data from third-parties. For example, access to consumer data may be restricted to consumer and system administrators. In some embodiments, consumer data that has had identifying personal data removed may be accessible to third-parties.
A notification of a monetary contribution or gift purchase may be made to the consumer. A notification may be a message sent to the consumer via email, SMS, text message, fax, etc. informing them of the third party actions.
A consumer account management system which may be used to manage registry accounts, associated bank accounts, contributions, and warehouse inventory.
An inventory fulfillment system may be part of, manage, or interface with the consumer account management system. Consumers may place orders for items, for example, through the registry once the items are paid for the order will be transmitted to the warehouse. The warehouse will locate the items and ship them to the address of record. Suppliers may need to be notified to send additional units of the items to the warehouse.
A benefactor may supply a contribution to a consumer. The contribution may be monetary, in-kind, or other service. Benefactors may include family, friends, co-workers, charitable corporations, or other third-party entities that do not provide insurance to the consumer.
Rules may be supplied by the benefactor that directs the contribution to particular products (e.g., pharmaceuticals, wigs, etc.) or services (e.g., co-pays, travel, etc.).
A vendor system may include an internal or third-party system that manages selling and/or delivering items. The vendor system may prohibit using benefactor supplied funds to purchase an item in non-compliance with the benefactor rules.
Digital currency is one of several similar terms applicable to the invention, such as electronic money, e-currency, e-money, electronic cash, electronic currency, digital money, digital cash, or cyber currency. These terms refer to money or scrip which is exchanged electronically using computer networks. Electronic Funds Transfer (EFT), direct deposit, and virtual currency are all common examples of electronic money. Digital currency expands on traditional currency such as coins, treasury notes, banknotes, coupons, and barter that is in circulation as a medium of exchange. Digital currency, as data subjected to data processing according to the invention, may be in any appropriate format and may be correlated with any other digital or non-digital medium of exchange, including paper money. A contribution from a benefactor may be a form of digital currency. Digital currency may be a medium for purchase of goods and services.

### ILLUSTRATIVE EMBODIMENTS

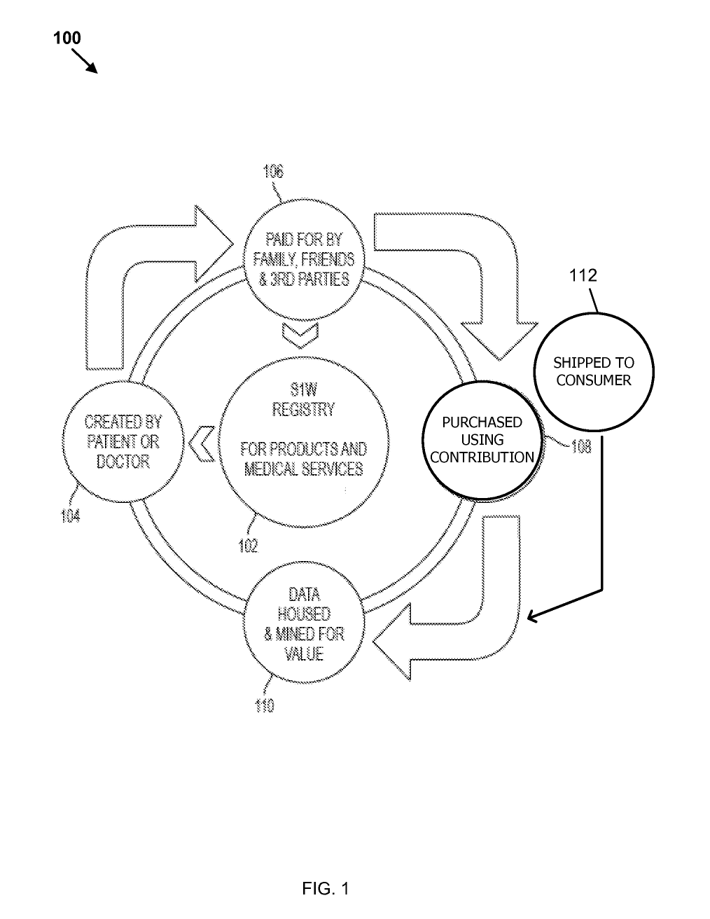

FIG. 1 depicts an illustrative high-level flow diagram 100 for use with an example embodiment for providing payment accounts. A secure, general registry system including a select catalog of products and services, and private, personal individual registries 102 of the products and services (which may be referred to generally as products or items) may be provided by an embodiment of the invention. A personal/individual registry within the registry system 102 may be created 104 by a consumer based on individual selections and/or from items in a “quicklist.” A quicklist may be created using the system by a third-party such as a doctor, healthcare provider, data analyzed within the computer system, etc, to bundle products together as dictated by their stage, or treatment cycle in their disease management. Items in the registry 102 may be purchased directly by the consumer, by third parties (e.g., friends, coworkers, community groups, family members, etc.), or contribution by third parties may be made 106. Contributions may include monetary, financial, coupons, tokens, in-kind services, sample offerings, digital currency, and/or trial offerings. Items purchased in step 106 may then be shipped to the consumer step 112. Alternatively, if a contribution was made, in step 108 the product or service (e.g., co-pay, travel, massage, acupuncture, prescription drugs, pharmacy items, etc.) may be purchased using the contribution or part of the contribution. As products and services are requested by a consumer and placed in the personal registry 102, additional contributions may be made 106, and the items may be shipped 112. By providing a mechanism of support, a consumer may have the financial support to complete their costly medical treatments and prescription drug purchases, which assists with compliance of their medical treatment and yields a healthier person.

Data on which products are recommended, requested, purchased, and shipped, as well as ratings of the products and services may be stored and mined for value 110, and used to determine the content of the catalog, recommendations for personal registries, and medical information, while complying with the stringent privacy requirements that may apply to personal health information.

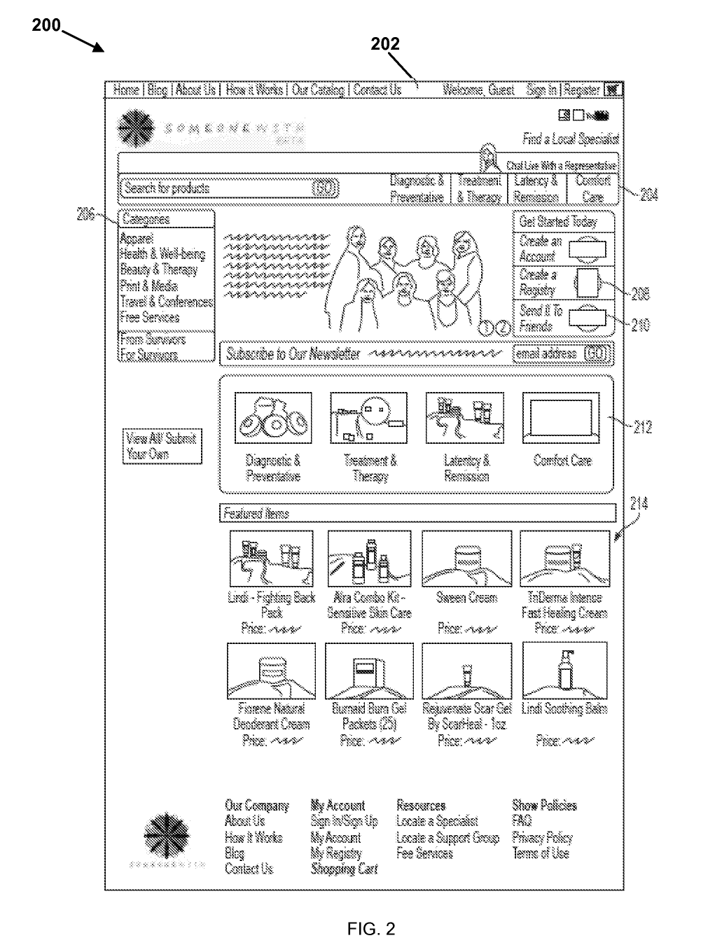

FIG. 2 depicts an illustrative home webpage 200 illustrating an example embodiment for providing payment accounts. The home page 200 may display, for example, a wide range of home health products and medical supplies 214. An embodiment of the invention may have drastically reduced the long hours of searching by aggregating the “best in class” products 214 and then bundling them based on varying treatment types 204. For example, a consumer that has been diagnosed with an illness (e.g., breast cancer, prostate cancer, lupus, arthritis, heart disease, autism, multiple sclerosis, sleep disorders, migraines, etc.) may be shown particular products and services 214 designed to increase the consumer's comfort and quality of life at each particular stage of the illness (e.g., preventative, discovery, diagnosis, treatment, therapy, latency, remission, recovery, comfort care, etc.) or treatment cycle (e.g., chemotherapy, radiation, surgery such as mastectomy or lumpectomy, etc.). Such stages or treatment cycles may be selected using, for example, the stage navigation bar 204 or sample stage products 212. In the case of breast cancer, for example, various products may include, for example, breast forms, specially designed bras, medical support garments, prosthetic designed skin care products, specially designed headwear and turbans, specially designed swimwear, relevant books, etc. In addition to specially designed products, services in-kind may also be offered. Services may include, for example, pet care, prosthetic fitters, specialists, travel, home cleaning, cooking, meal delivery, pet finder, babysitting, driving, carpooling, real estate (e.g., eldercare, hospice, house swaps for people with illnesses, vacation houses, tax deductible houses, etc.), yard work, sponsor a day of co-pay, gift cards, massage, etc. Various categories (e.g., apparel, health & wellbeing, beauty & therapy, print & media, travel & conferences, free services, etc.) may, for example, be selected using the categories navigation menu 206. Video tutorials may also be provided on for example, how to use a product or how to measure yourself for a product. The selected services may be considered candidates for their registry, on behalf of the consumer. The home page 200 may also have a top-level navigation bar 202 for navigating to pages such as home, blog, about us, how it works, catalog, contact us, etc. A registry 102, 300 may also be created from this page by, for example, selecting the “create a registry” button 208. The registry 102, 300 may be sent to a third party, via, for example, a “send it to friends” button 210.

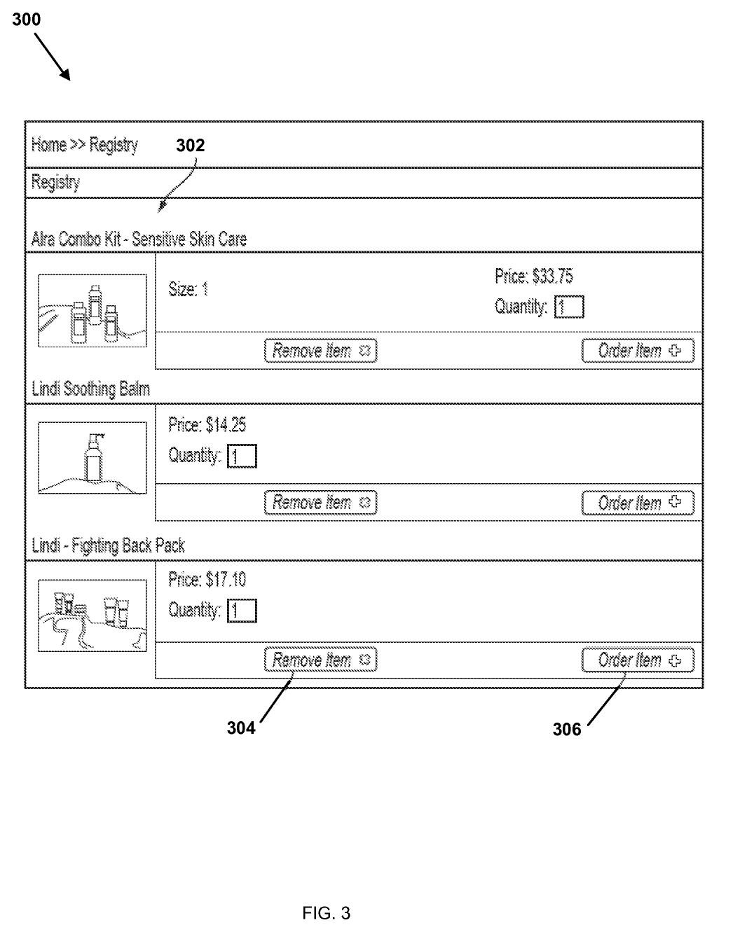

FIG. 3 300 depicts an illustrative consumer registry page. The products and services 302 shown may represent products and services selected by the consumer for their registry. Products and services 302 may be ordered by selecting, for example, the Order Item button 306. Products and services 302 may be removed from the registry by selecting, for example, the Remove Item button 304.

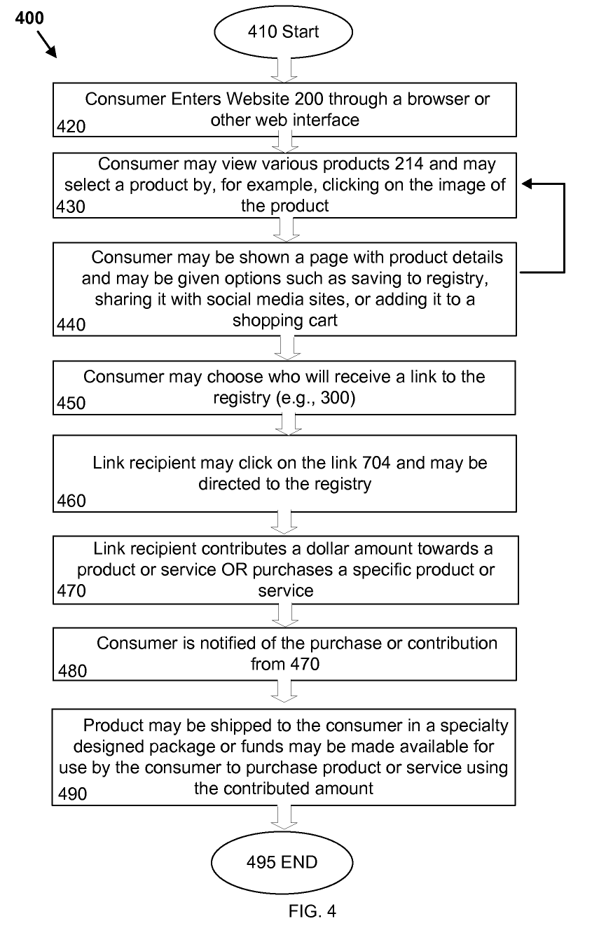

FIG. 4 depicts illustrative consumer workflow 400 for use with an example embodiment for providing payment accounts. Although the flow is depicted as a linear progression, the flow is not necessarily linear. Flow may occur at any point in the diagram. Flow may begin at start 410. From start 410, flow may move to 420 where a consumer may enter the website 200, for example. At 420 a consumer may log into their web account, for example, through account registration. In one embodiment, a consumer may be automatically logged on into their account. From 420 a consumer may move to 430 and view the various products and services 214 on the website 200. In 430 a consumer may select an item (e.g., click on image) and move to 440. At 440, a consumer may be shown a product page with details on the selected product. A products and services page may have buttons such as “Add to Cart,” “Add to Registry,” and “Share.” If a consumer wishes to register the item a consumer may select the “Add to Registry” option and the product may be saved into a registry 102, FIG. 3 300. In an alternative embodiment, products and services 214 may be added to the registry 102, 300 from a Multiple Add to Cart button. In some implementations, products and services 214 may be added to the registry 102, 300 in bulk.

The flow may repeat back to 430 to choose more products and services 214. The consumer may also be able to prioritize the selected products and services so that the higher priority products and services may be purchased before the lower priority products and services. From 440, flow may proceed to 450. At 450 a consumer may choose how and who should know about the consumer's registry 102, 300. A consumer may be given several options; for example, email the page link or an embodiment of the invention may manage a social media campaign, for example, on the consumer's behalf. Such a campaign may let those who are identified by the consumer and interested in supporting the consumer, know about the registration. Only chosen contacts may have access to the consumer's individual registry 102, 300. In another embodiment, within the registry 102, 300 a web template may be displayed to “tell people about your registry—email them this link,” for example. The link may allow a contributor to access the registry 102, 300 without searching or logging in. The registry 102, 300 may be, for example, cookie based yet still comply with, for example, HIPAA.

The consumer may use a built-in email type system similar to that of, for example, Send to Friend, where a “send email” page is supplied and the consumer may send one or more links off to chosen recipients, or alternatively the consumer may go into a third party email system (e.g., Gmail, Hotmail, Outlook, etc.) and send one or more links off to chosen recipients.

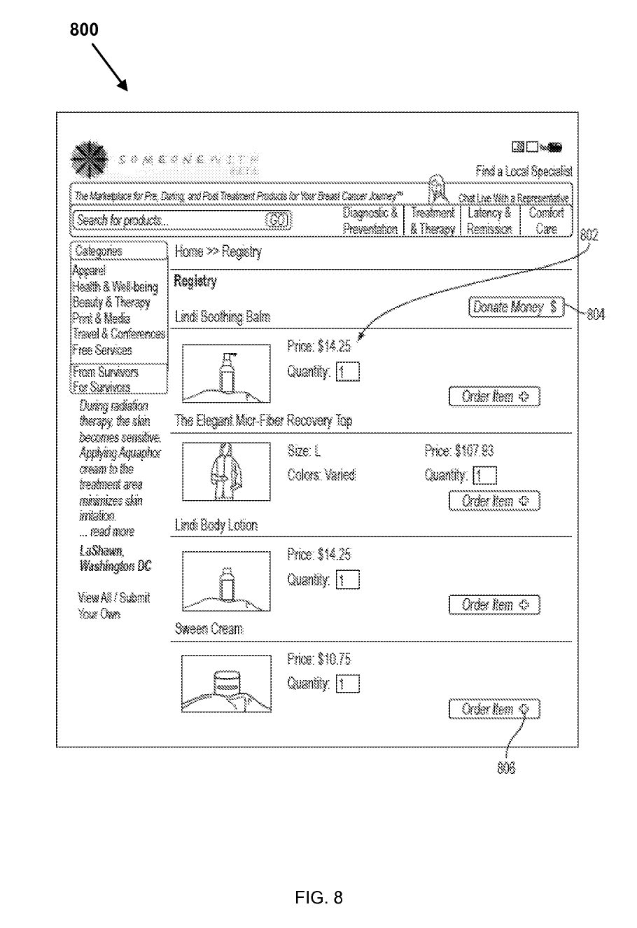

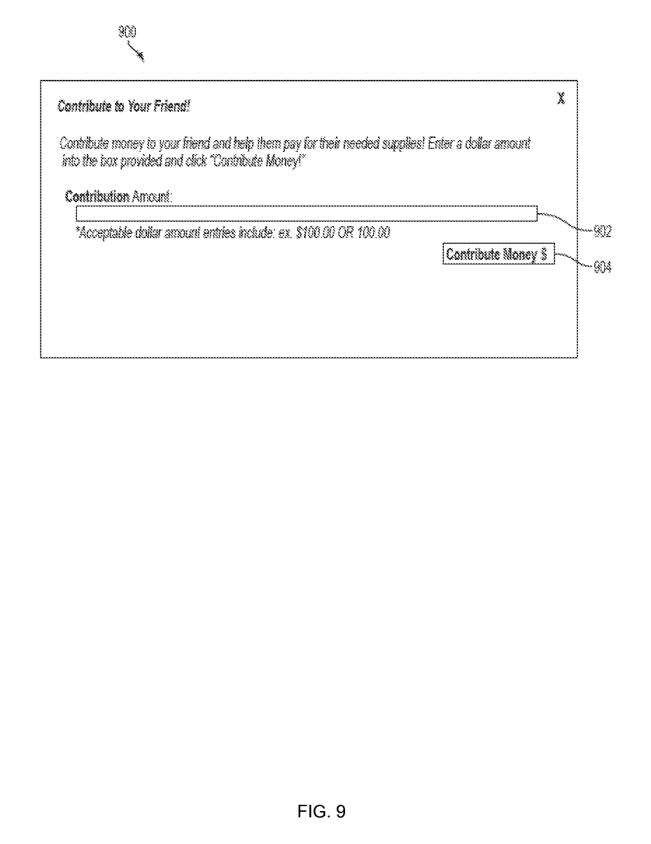

From 450 flow may proceed to 460 where a recipient of the link may click on the link and may be directed to the registry 102, FIG. 8 800. From 460 flow may proceed to 470, where the link recipient may contribute a dollar amount FIG. 9 900 toward the cost of a product 300 or service on the consumer's registry 102, 800 or may purchase a specific product or service off the consumer's registry 102 800. From 470, flow may then proceed to 480, where the consumer may be notified (e.g., via email) of the gift from the consumer. From 480, flow may proceed to 490, where once the product from 470 is purchased, the product is shipped to the consumer in a beautifully packaged, discreet, box. In 490, if the recipient of the link contributed money, the contributed funds may be made available for use by the consumer to purchase items using the contributed funds. From 490, flow may then end at 495.

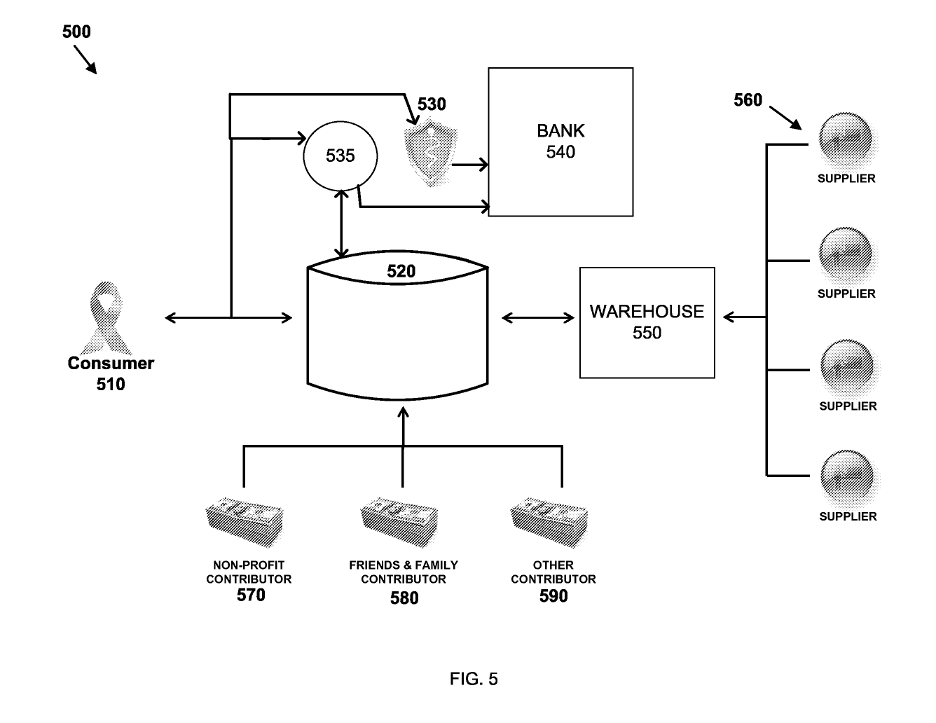

FIG. 5 depicts illustrative process flow diagram 500 for use with an example embodiment for providing payment accounts. The process flow diagram 500 may include consumer or patient 510, a consumer account management system 520, a healthcare provider 530, an item provider 535, a bank 540, a warehouse 550, suppliers 560, and non-profit contributor 570, friends and family contributor 580, and other contributor 590.

Consumer 510 may be an individual with a specific disease or disorder.

Consumer account management system 520 may provide a centralized location to coordinate consumer 510 registry items, contributions (e.g., digital currency), and distribution of purchased items.

Healthcare provider 530 may be a provider of healthcare related services. Healthcare provider may include both external and internal providers. Internal providers may include items that are supplied by warehouse 550. External providers may include retail providers and other on-line providers of healthcare items (e.g., CVS pharmacies, Walgreens, etc.).

Item provider 535 may include providers that are outside of the supply chain and may include providers of services such as travel, massage, etc.

Bank 540 may be a bank or other financial institution capable of maintaining an account associated with funds.

Warehouse 550 may be a warehouse associated with consumer account management system 520.

Suppliers 560 may provide items (e.g., health related items) to warehouse 550.

Consumer 510 may create a registry 300 using the consumer account management system 520. Consumer 510 may select items from warehouse 550 for inclusion in registry 300. Consumer 510 may also select items not in warehouse 550 for inclusion in registry 300. Items not in warehouse 550 may be purchased at external healthcare providers 530 or item provider 535. Items not in warehouse 550 may be identified by an item code, for example.

Non-profit contributor 570 (e.g., religious organizations, charities, etc.), friends and family contributor 580, and other contributor 590 may provide funds for the purchase of items and services to consumer 510 though the consumer account management system 520. Contributors may contribute money for designated (or directed) items or services or they may provide undesignated (or undirected or unrestricted) contributions. Designated contributions may restrict the items or services that may be purchased by consumer 510. Funds may be allocated for specific items or services or funds may be allocated for a type of item or service. Contributors may also be identified as benefactors. In an embodiment, contributors do not include an insurance provider, a government agency, or the consumer.

Consumer account management system 520 may establish an account with bank 540 for consumer 540. Bank 540 may provide consumer 510 with a debit card or other mechanism to allow access to funds stored in bank 540. Contributions made to consumer 510 from non-profit contributor 570, friends and family contributor 580, and other contributor 590 may be deposited in bank 540. Contributions may be made via credit card, mobile device, on-line (e.g., PayPal), check, lock box, etc.

Consumer account management system 520 may also include or manage an inventory tracking system that manages the tracking of items ordered from consumers to the shipment of the items to the consumer.

Consumer 510 may interact with healthcare provider 530 or item provider 535. Contributed funds may be used to pay for costs associated with healthcare provider 530 or item provider 535 though accessing account with bank 540, for example.

Items purchased by consumer 510 that are in warehouse 550 may be shipped from warehouse 550 to consumer 510.

An embodiment of this invention may be implemented by software, hardware, or a combination of software and hardware. In one embodiment, consumer account management system 520 may include several modules that may be implemented by software, hardware, or a combination of software and hardware.

For example, in one embodiment consumer account management system 520 may include a consumer account creation module, a funds account creation module, an inventory tracking system, a funds receiving module, a benefactor rules module, a purchase data receiving module, a database, a data consolidation module, and/or a vendor integration module. The consumer account creation module may allow the creation of a consumer account associated with on-line registry 102, 300. The funds module may allow for creating and/or initiating creation of a funds account in, for example, bank 540. The funds account may be associated with the consumer account. The inventory tracking system may enable tracking one or more of the specialty items listed in the catalog. The inventory tracking system may be associated with warehouse 550 and suppliers 560. The funds receiving module may enable receiving funds directed to the consumer account from, for example, a benefactor (e.g., not the consumer, a government agency, or an insurance provider). The benefactor rules module may enable associating received funds with rules from the benefactor (e.g., the rules designate items in the on-line registry 102, 300 that may be purchased with the funds given by the benefactor). The purchase data receiving module may enable receiving purchase data of an item designated from the on-line registry 102, 300 in accordance, for example, to the rules from the benefactor. The database may be used for consolidating purchase data across multiple retail outlets, for example. The vendor integration module may enable integration with a vendor system, such as those implemented by healthcare provider 530 or item provider 535. The vendor system may be integrated with the consumer account management system or the vendor system may be a third-party vendor system. An item may be associated with the vendor system and the item may be added from the catalog to the on-line registry 102, 300. The data consolidation module may enable consolidating data from multiple consumers using the database, for example.

In another embodiment consumer account management system 520 may include a consumer account creation module, a funds account module, a contribution receiving module, a benefactor rules module, a purchase data receiving module, and/or a database. The consumer account creation module may create a consumer account associated with a consumer. The funds account module may associate a funds account with the consumer account. The contribution receiving module may receive a contribution directed to the consumer account from a benefactor and may also credit the contribution to the consumer account. The benefactor may not be the consumer, a government agency, or an insurance provider. The benefactor rules module for associating the contribution (e.g., digital currency) with rules from the benefactor. The rules may designate a purchase of one or more specialty items relevant to a particular disease or disorder at a given stage or treatment cycle of the disease or disorder. The purchase data receiving module may receive purchase data regarding the one or more specialty items, where the items may have been purchased by the consumer in accordance to the rules from the benefactor. The database may store data on at least one of: purchases, the one or more specialty items, consumers, sales transactions, the disease or disorder, etc.

In an embodiment, consumer account management system 520 may include a vendor integration module which may integrate a vendor system with the consumer account management system. The specialty items may be associated with the vendor system. An inventory tracking system may also be included for tracking the specialty items associated with the vendor system or for items selected from an on-line registry.

In an embodiment of the invention, a consumer may attempt to use benefactor funds to purchase items or items not selected by the benefactor. The consumer account management system 520 in coordination with the vendor system and/or the vendor integration module, for example, may prevent the benefactor supplied funds from being used to purchase the consumer selected items. In other words, a consumer may be prevented from purchasing an item in non-compliance with the benefactor rules.

In an embodiment the database may store data such as account data, consumer data, warehouse data, and/or vendor system data. Account data may include transaction information, account balance information, and/or contribution information. Multiple consumer data may include demographic information, disease state information, annual income information, geographic information, and/or item preference information. Warehouse data may include inventory turns information, cycle time information, lead time information, and/or cost of goods sold information. Vendor system data may include claims utilization information, patient responsibility information, store information, item information, and/or spending statistics. A data consolidation module may also be provided to assist in consolidating data from multiple consumers.

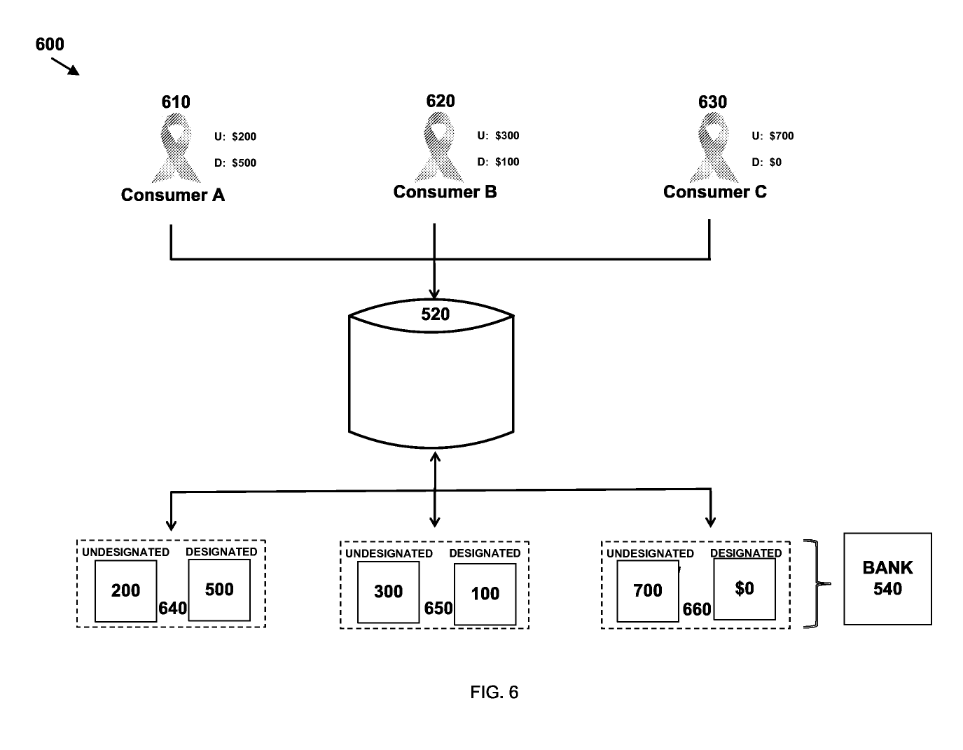

FIG. 6 depicts illustrative currency model 600 for use with an example embodiment for providing payment accounts. Illustrative currency model 600 may contain consumer account management system 520, bank 540, consumers 610, 620, and 630, and financial accounts 640, 650, and 660.

Consumers 610, 620, and 630 may set up registry accounts with consumer account management system 520. Consumer account management system 520 may associate the registry accounts with financial accounts 640, 650, and 660, established at bank 540 for consumers 610, 620, and 630. Consumer account management system 520 may provide on-line enrollment, vetting, and banking functions. Contributors may contribute funds to consumers 610, 620, and 630. The contributed funds may be deposited into financial accounts 640, 650, and 660. Within financial accounts 640, 650, and 660, the accounts may be partitioned further and may include designated and undesignated accounts.

Contributed funds that have no specific item or item type designation may be deposited into the undesignated account. The funds in an undesignated account may be used by the account holder (e.g., consumer 610, 620, and/or 630) for any purpose. The undesignated account fund may be accessible, for example, via an automated teller machine (ATM). In one embodiment, the undesignated account may be considered the primary account which may be undesignated or unrestricted.

On the other hand, funds where the contributor designated an item, items, or an item type may be deposited into a designated account. In one embodiment, designated accounts may be a secondary account. Additionally, each financial account 640, 650, 660 may have multiple designated accounts, for example, one for each item type. The designated accounts may be associated with codes that designate the item or item type that the consumer may purchase. Such codes may include merchant category codes (MCC), item codes, stock-keeping unit (SKU) codes, universal product codes (UPC), standard industrial classification (SIC) codes, North American industry classification system (NAICS) codes, or global industry classification standard (GICS) codes.

Accounts 640, 650, 660 may be accessed, for example, via a debit card, credit card, online, e-wallet, wire transfer, mobile, etc. Accounts 640, 650, 660 that are abandoned (e.g., consumer 610, 620, and/or 630 does not survive the disease or disorder) may be escheated to a third-party foundation.

In an embodiment consumer account management system may be the funds processor (e.g., First Data). The funds processor may process funds and manage financial transactions and coordinates payment of payment for the entities (e.g., transfer funds from consumer account to vendor account). The funds processor may be associated with the point of sale such as a credit card swipe machine or a website checkout. The consumer account management system may also manage card association such as with MasterCard, Visa, Discover, American Express, etc.

In one example, using consumer account management system 520, a contributor or contributors may contribute $200 for general spending (e.g., undesignated or undirected) and $500 towards a specific item or items for consumer 610. Bank 540 may establish account 640 with $200 as undesignated and $500 as designated. Accordingly, consumer 610 may spend the $200 on the items of her choice while she is designated or restricted to spending the $500 only on items selected by the contributor or contributors.

In another example, using consumer account management system 520, a contributor or contributors may contribute $300 for general spending (e.g., undesignated) and $100 towards a specific item or items for consumer 620. Bank 540 may establish account 650 with $300 as undesignated and $100 as designated. Accordingly, consumer 620 may spend the $300 on the items of her choice while she is designated or restricted to spending the $100 only on items selected by the contributor or contributors. In this example, if the $100 was designated towards the purchase of, for example, co-pays, when the consumer 6200 is asked for a co-pay by healthcare provider 530, consumer 620 may use the associated debit card, for example, to pay for the co-pay. Each time the consumer 620 uses the debit card, for example, to pay for co-pays the designated funds of account 650 will be deducted by the amount of the co-pay. In this example, consumer 620, may spend the undesignated $300 (or a portion of the undesignated $300) from account 650 on any products or services. When consumer 620 uses a debit card, for example, that is associated with account 650 for items that are not designated, the undesignated account will be reduced by the purchase amount. In the event that the undesignated funds are depleted and the consumer 620 uses the debit card, for example, that is associated with account 650 for items that are not designated, the consumer 620 may be denied the purchase by the merchant.

In yet another example, using consumer account management system 520, a contributor or contributors may contribute $700 for general spending and nothing towards a specific item or items for consumer 630. Bank 540 may establish account 660 with $700 as undesignated and $0 as designated. Accordingly, consumer 630 may spend the entire $700 on the items of her choice.

In an embodiment, a debit card that is associated with the accounts may be an option to purchase from consumer account management system 520. Accordingly, a contributor may purchase a debit card for consumer 610 and/or consumer 610 may place the debit card associated with consumer 610 account in the registry.

In another embodiment, coupons, sample items, and/or promotional items from manufactures, marketing firms, charities and/or 3^{rd} parties may be added into a consumer 610 account. For example, a manufacturer could provide funds and designate them for purchase of a trial size of a product. The consumer 610, may then, for example, bring the associated debit card to a retail store and purchase the trial size of the product using the debit card.

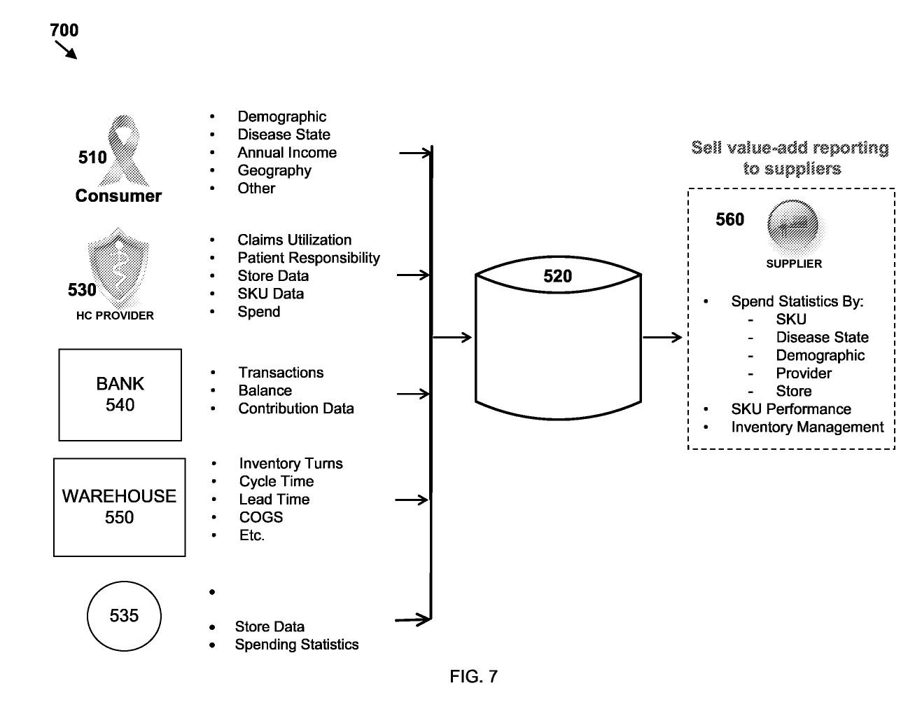

FIG. 7 depicts illustrative data monetization model 700 for use with an example embodiment for providing payment accounts. Illustrative data monetization model 700 may include consumer 510, consumer account management system 520, health care provider 530, item provider 535, bank 540, warehouse 550, and suppliers 560.

Consumer account management system 520 may collect and retain information from consumer 510, healthcare provider 530, item provider 535, bank 540 and warehouse 550. Information from consumer 510 may include, for example, demographics, disease state, annual incomes, geography, purchase preferences, etc. Information from healthcare provider 530 may include, for example, claims utilization, consumer responsibility, store data, purchase data, item data (e.g., SKU data), spending data, etc. Information from item provider 535 may include, for example, purchase data (e.g., SKU), store data, spending statistics, etc. Information from bank 540 may include transactions, balance, average balance, low balance, high balance, contribution data, etc. Information from warehouse 550 may include inventory turns, cycle time, lead time, cost of goods sold (COGS), etc.

Consumer account management system 520 may sell or provide suppliers with compiled information such as spend statistics by item code (e.g., SKU), disease state, demographic, provider, store. Consumer account management system 520 may also provide item (e.g., SKU) performance and/or inventory management.

The above mentioned data may be stored the database associated with the consumer account management system 520. The above mentioned data may be collected or used by, for example, the consumer account creation module, the funds account creation module, the inventory tracking system, the funds receiving module, the benefactor rules module, the purchase data receiving module, the database, the data consolidation module, and/or the vendor integration module.

FIG. 8 800 depicts an illustrative registry page for a contributor. A contributor may use webpage 800 to contribute to the consumer. A contributor may purchase items or services 802 for the consumer. A contributor may also contribute a monetary amount for the consumer by selecting a button such as a “Contribute Money” button 804. The monetary amount may be used by the consumer generally or for specific contributor identified products and/or services. The specific contributor identified products and/or services may be listed on the registry or the contributor may be able to select specific categories to contribute towards (e.g., co-pay, acupuncture, prescription medicine, over the counter medicine, etc.).

FIG. 9 900 depicts an illustrative monetary contribution page. Amount field 902 may allow the input of a monetary contribution amount. Once an amount is entered in the amount field 902, a Contribute button 904 may be pressed to confirm the monetary amount contributed. The monetary contribution page may vary depending on whether the contribution is designated or undesignated. In a designated contribution, the selected items or item type may also be displayed.

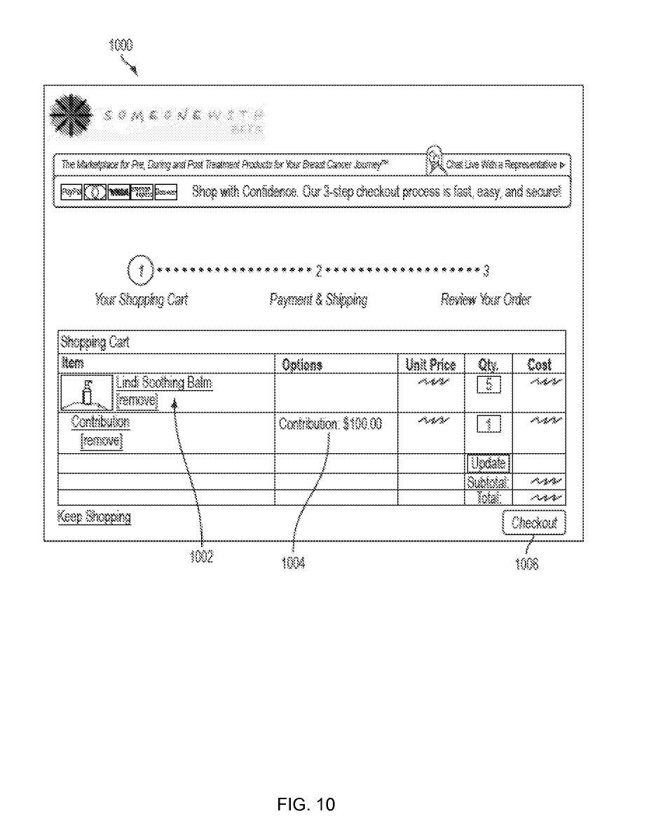

FIG. 10 1000 depicts an illustrative shopping cart. The shopping cart 1000 may depict products and services selected for purchase 1002 including a monetary contribution amount 1004. Pressing the Checkout 1006 button may confirm that the products, services and contribution amount 1002 wish to be purchased. In a designated contribution, the selected items or item type may also be displayed.

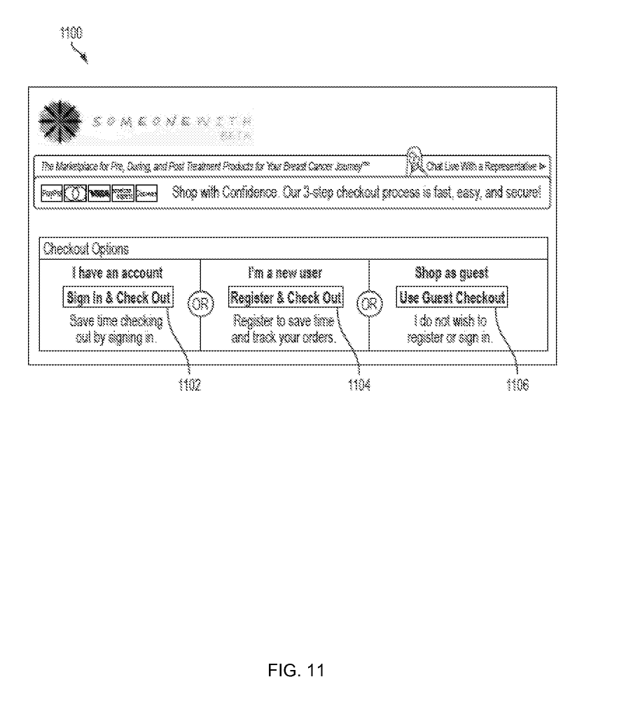

FIG. 11 1100 depicts an illustrative checkout options page. To purchase products, services, and/or monetary contributions, a contributor may have the following options. If the contributor has a current account the contributor may select Sign in and Checkout 1102. If the contributor is a new user, the contributor may select Register and Checkout 1104. If the contributor does not wish to setup an account, the contributor may select Use Guest Checkout 1106. In alternate embodiments, the contributor may be automatically logged in.

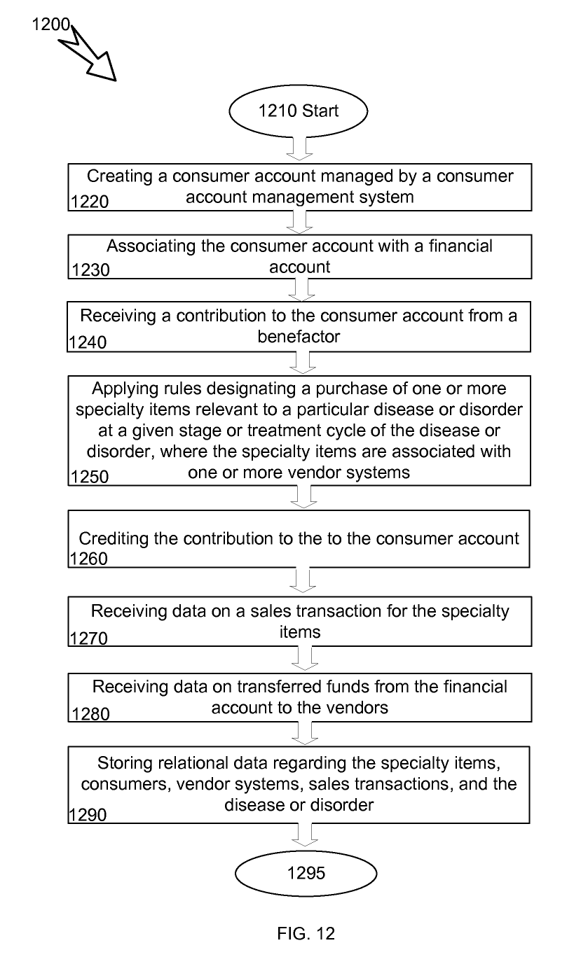

FIG. 12 depicts illustrative workflow 1200 for use with an example method of providing payment accounts. Flow may begin at start 1210. From start 1210, flow may move to 1220. In 1220 a consumer account for a consumer may be created. The consumer account may be managed, for example, by a consumer account management system. From 1220, flow may move to 1230.

In 1230, the consumer account may be associated with a financial account. The financial account could be, for example, a bank account. Contributors making, for example, a financial contribution to the consumer account may have the funds deposited in the financial account. From 1230, flow may move to 1240.

In 1240, a contribution to the consumer account may be received from a benefactor. The benefactor may include family, friends, coworkers, charities and may not include the consumer, a government agency, or an insurance provider. From 1240, flow may move to 1250.

In 1250, rules designating a purchase of one or more specialty items relevant to a particular disease or disorder at a given stage or treatment cycle of the disease or disorder may be applied. The specialty items may be associated with one or more vendor systems. The vendor systems may be integrated with the consumer account management system or may be third-party vendor systems. From 1250, flow may move to 1260.

In 1260, the contribution to the consumer account may be credited. From 1260, flow may move to 1270.

In 1270, data on a sales transaction for the one or more specialty items may be received. From 1270, flow may move to 1280.

In 1280, data on transferred funds from the financial account to the one or more vendors may be received. From 1280, flow may move to 1290.

From 1290, relational data may be stored. Data may include the specialty items, consumers, vendor systems, sales transactions, and/or the disease or disorder. From 1290, flow may move to 1295 and end.

In another embodiment, the consumer account may be associated with an on-line registry and managed by consumer account management system 520. Consumer account management system 520 may also be associated with an inventory tracking system. A consumer selected item from a catalog may be added to the on-line registry. The item may be associated with a vendor system, for example. The vendor system may be integrated with the consumer account management system 520 or the vendor system may be a third-party vendor system. A funds account associated with the consumer account may be established. The funds account may be, for example, an account in bank 540. Funds directed to the consumer account may be received from a benefactor. The benefactor may not be the consumer, a government agency, or an insurance provider. In other words, the benefactor may be a friend, acquaintance, or family member of the consumer, a non-profit organization, or a corporation wherein the contribution may not be associated with insurance of the consumer. The funds may be associated with rules from the benefactor which designate items in the on-line registry that may be purchased. Purchase data of an item designated from the on-line registry in accordance to the rules from the benefactor may be received. Purchase data may be consolidated across multiple retail outlets.

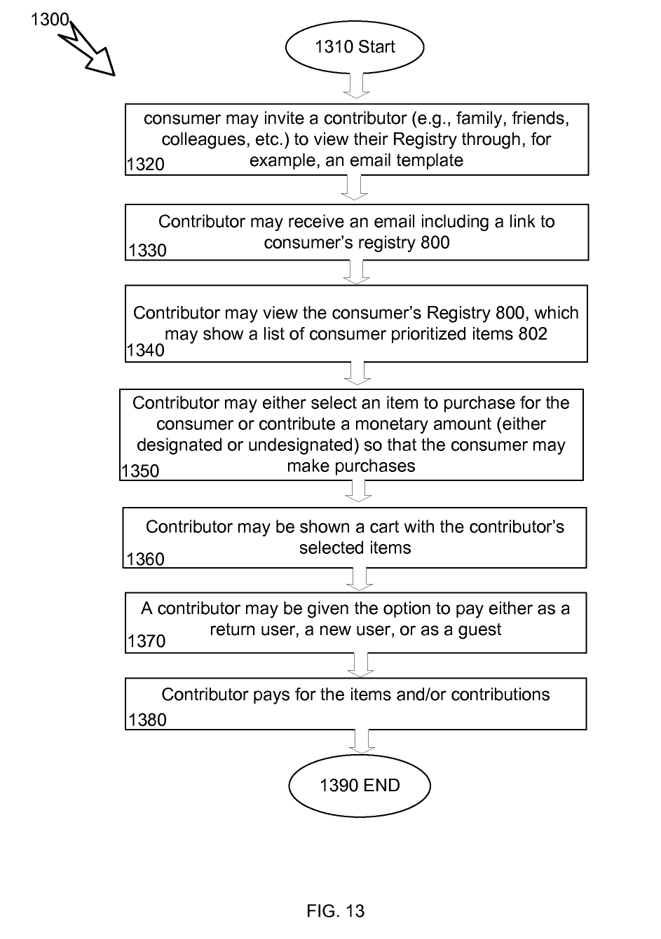

FIG. 13 depicts illustrative contributor workflow 1300 for use with an example embodiment for providing payment accounts. In 1300, flow may begin at start 1310. From 1310 flow may move to 1320. In 1320 the consumer may invite at least one contributor (e.g., a third-party, family, friends, colleagues, etc.) to view the consumer's registry 800. The consumer may use an email template, for example, which may include a secure link to the consumer's registry. From 1320 flow may move to 1330.

In 1330 the contributor may receive an email, for example, which may include a secure link directing them to the consumer's registry 800. From 1330 flow may move to 1340.

In 1340 the contributor may view the consumer's registry 800. The consumer's registry may contain a list of consumer prioritized items 802. In some embodiments, the contributor may be required to enter login information or may be automatically logged in. In alternate embodiments, the consumer may personalize or customize a contributor's view. For example, the contributor's view that has been customized may display a personalized message or messages or display only certain registry items (e.g., display only Kosher items, display only organic items, display only items less than a certain amount, display items exceeding a dollar amount, etc.) The contributor view 800 may vary from the consumer view of the registry 300. For example, the consumer may see contribution amounts and registry items, while the contributor may see the registry items without the total contribution amounts from all contributors. Also, a contributor may be given the option to make a contribution 804. A session flag may be used to specify various view, for example, either a consumer or contributor views.

In one embodiment, third-parties may be able to purchase products, services, or make a monetary contribution for consumers based on certain consumer criteria volunteered by them in order to access said benefit (e.g., located in a certain area, have breast cancer, particular ethnic group, income level/financial status, etc.). This type of contribution may be done without access to a consumer's registry.

From 1340 flow may move to 1350. In 1350 the contributor may select an item to purchase for the consumer or may contribute a monetary amount. The monetary amount may be in the form of designated or undesignated. With a designated contribution, the contributor may choose which products and services to purchase. In one embodiment, if an undesignated or general monetary contribution was made, the system may automatically apply the contribution to the highest prioritized product or service on the consumer's registry 300 (if that option was selected by the consumer/patient). If the consumer has enough funds, the product or service may be purchased and shipped to the consumer. Several products and/or services may be purchased and shipped depending on the amount of the contribution and the remaining money in the consumer's account. In alternate embodiments, the contributor may make a general monetary contribution or one or more monetary contributions designating specific item or items or towards a specific category of items (e.g., the money can only be spent on nutrition/fitness related services, co-pays, food, prescriptions, etc.). If a contribution is made to a specific item, for example, the consumer may only use that particular contribution towards that particular item. A running tally of contributions may be kept within a database or application 1510. This may be used in the confirmation page later to deduct during purchases, as well as when contributors contribute to the consumer on their gift registry page.

A contributor may also purchase one or more services for the consumer. Where a physical product is not purchased, several methods may be used to notify the consumer of the purchase. The consumer may receive a notification (e.g., via email, mail. Fax, etc.) that a particular service was purchased for the consumer. Such notification may include, for example, a gift certificate or specialized card that the consumer may present to receive the service. In one embodiment, a special debit or credit credit card (e.g., VISA®, MASTERCARD®, AMERICAN EXPRESS®, etc.) which may only be used for specific purposes may be delivered to the consumer. The specific purpose may be defined for example, by only allowing purchases for services with an identified item code, merchant mode, SIC, NAICS codes, etc. The customized card may itself be a product for sale from the products and services 214. Even items that are not available in warehouse 550 may be selectable from a catalog to place in the on-line registry. Items selected from the catalog may have associated item codes that may enable designated or restrictive purchases.

From 1350 flow may move to 1360. In 1360, after the contributor has made product and/or service selections 802 and/or determined an amount of money to contribute 900, contributors may be shown a cart 1000 with their selected items 1002. From 1360 flow may move to 1370.

In 1370 the contributor may be given several checkout choices. The checkout choices may include, for example, check out as a return user, check out as a new user, and/or check out as a guest. From 1370 flow may move to 1380.

In 1380, the contributor may have selected an appropriate button 1102, 1104, or 1106 and a payment screen may be displayed to capture payment information. If a contributor purchased products or services or contributed money, the contributor may begin a checkout process. Once a contributor begins the checkout process, their ship to information, for example, may be populated with the ship to information for the consumer associated with the gift registry 102, 300. The session information, for example, may be used to pull the consumer mailing address. The billing address may be that of the contributor. From 1380 flow may move to 1390 and end.

In another embodiment, after a monetary contribution is made the following may happen. The consumer associated with the gift registry 300 may see a dollar value associated within their registry 300. The consumer may, for example, select an item or group of items from the registry 300 to purchase and add them to an electronic shopping cart. Once the items are in an electronic shopping cart, because they are logged into their account and have money contributed to it, they may see an option to “checkout with contributions.” The electronic shopping cart total may reflect the amount of the order minus the amount of contributions applied. If, for example, the contribution amount is greater than the total, only the amount needed to make the purchase may be applied, however, if the amount of contributions is less than the order total, credit card information, for example, may be required on the shipping and billing page to make up the difference and complete the related order. The ship to and bill to addresses may be populated automatically from previously entered data. The consumer may get a confirmation page which displays the order amount. The order amount may be deducted from the contributions total for that gift registry 300, and the purchased items may be removed or crossed off from the list.

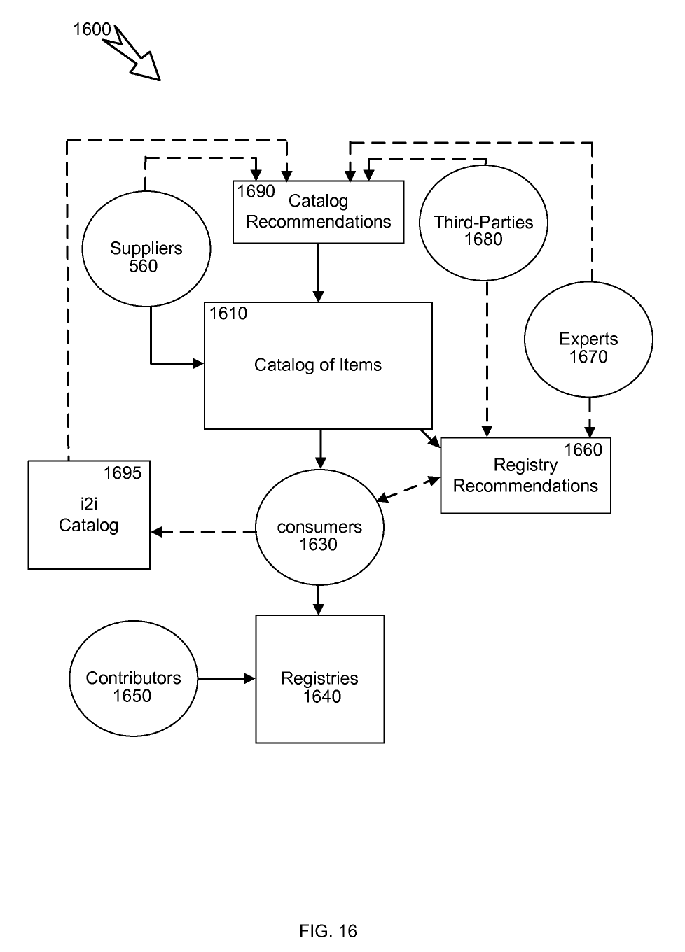

FIG. 16 depicts an illustrative high-level system flow diagram 1600 for use with an example embodiment for providing payment. In an example embodiment, catalog of items 1610 may be created which may include specialty items (e.g., products and services) that may be targeted for a particular disease or disorder at a particular stage or treatment cycle. Items in catalog of items 1610 may be selected for their relevance to a particular disease or disorder at a particular stage or treatment cycle. For example, during the treatment stage for breast cancer, non-metallic deodorant (deodorants made with metallic ingredients may interfere with radiation treatments) may be an item in catalog of items 1610. Items in catalog of items 1610 may have been selected through roundtables of doctors and patients.

The items in catalog of items 1610 may be provided by suppliers 560. Suppliers 560 may include wholesale and retail distributors of medical items and providers of services. Consumers 1630 may purchase from catalog of items 1610. Additionally, consumers 1630 may select items from catalog of items 1610 for entry into registries 1640. Consumers 1630 may include individuals suffering from the disease or disorder or entities associated with an individual suffering from the disease or disorder. Each consumer in consumers 1630 may be associated with a secure personal registry from registries 1640. A secure personal registry may be a collection of items chosen by a consumer which is accessible only by the consumer who created the registry or by entities selected by the consumer who created the registry. In another embodiment, consumers 1630 may be associated with multiple registries from registries 1640.

Contributors 1650 may contribute money or in-kind services to consumers 1630 based on the selected items in registries 1640. Contributors 1650 may include, for example, friends, coworkers, community groups, foundations, employers, religious organizations, family members, trusts, etc. Consumers 1630 may choose items for inclusion into their registries 1640 based on registry recommendations 1660. Registry recommendations 1660 may contain one or more items from catalog of items 1610. Registry recommendations 1660 may be created from experts 1670, third-parties 1680, and/or consumers 1630. Registry recommendations 1660 may also be referred to as quicklists. Registry recommendations 1660 may allow consumers 1630 to quickly select wanted items from the catalog of items 1610.

Suppliers 560, consumers 1630, experts 1670, and/or third-parties 1680 may make catalog recommendations 1690 for items to remove from or include with the catalog of items 1610. Catalog recommendations 1690 may also come from sales data (e.g., items that have low sales over a period of time may be selected for removal from the catalog of items 1610). Items from the catalog recommendations 1690 may be included in the catalog of items 1610 through the system.

In one embodiment, a crowdsourced product selection process may exist. The crowdsourced product selection process may be implemented using i2i catalog 1695. i2i catalog 1695 may contain a large selection of items for viewing but not available for purchase. A link may be available that may allow consumers 1630 to browse through categorized products and vote for items to be included in the catalog of items 1610. Once a pre-set threshold of votes has been obtained for an item in i2i catalog 1695, the item may be added into catalog of items 1610 and available for purchase or selection into registries 1640. For example, when an item receives the necessary number of votes the system may contact (e.g., email, SMS, etc.) procurement to begin the process of negotiating with product manufacturers, for example. If an item becomes available for purchase, consumers who voted for the item may be automatically notified that the newly acquired item is available for purchase or selection into registries 1640. The notification email may include links to in stock items that have received votes. Additionally, a link may automatically populate their ‘cart’ with all items they voted for so that they may go straight to checkout and purchase all of the newly inventoried items.

Consumers 1630 may be encouraged to spend time browsing and voting for new items through the following. First, accessible items (e.g., items in i2i catalog 1695) may be listed under ‘similar items’ on various product level pages, so that consumers 1630 reviewing and purchasing in stock items can see variations that may be added into catalog of items 1610. Consumers 1630 may be able to vote for that product to be brought in straight from the product page they are currently viewing. Second, during checkout, consumers 1630 may be offered immediate discounts on their current purchases for reviewing items (e.g., 20-30 items) and voting for items they would like to see included in catalog of items 1610. For example, when a consumer agrees to participate, a new pop-up may display 20-30 items, then, they vote for the items they want and submit their ‘ballot’ at which point they may be returned to their can with the discount already applied.

Data from flow 1600, including data on catalog of items 1610, suppliers 560, consumers 1630, registries 1640, contributors 1650, registry recommendations 1660, experts 1670, third-parties 1680, and catalog recommendations 1690, may be stored in, for example, a relational database. Data on consumers 1630 may be maintained to comply with current local, state, and/or federal regulations (e.g., HIPAA). Such compliance may include keeping personal (e.g., name, mailing address, etc.) information separate from other data (e.g., supplier 560, experts 1670, etc.). The data from the relational database may be mined for value in compliance with the privacy of the personal consumer data.

In the event that products and services are no longer needed (e.g., the consumer fully recovers or suffers a catastrophe) and money is still in the registry 300, the money may not go directly to the consumer but may instead be given to a selected charity or the money may be distributed to other similarly situated consumers, for example. Every attempt may be made to locate and contact the consumer but after an excessive period of time (e.g., 18 months) any residual money in the consumer's account may be distributed according to the wishes of the consumer, for example. In some situations, a contribution may be considered a donation depending on the recipient.

### Additional Embodiments

An embodiment of the invention may include sections with advice (e.g., prior users, survivors, doctors, healthcare providers, vendors, certifying bodies, etc). The offered products and services 214 may be rated, reviewed and shared by consumers, patients, and/or caregivers allowing a consumer to benefit from the knowledge and experiences of other individuals. Consumers may be asked to rate 308 and review 306 any items that may have been previously used (regardless of where the item was purchased).

The system may be self-governing in that the provided products and services 214 are determined from the collective input of consumers. For example, the products and services 214 may be rated 308 by consumers and/or third parties. New products and services may be added to the offered list of products and services 214 if requested by a number of consumers. Alternatively, products and services may be removed from the offered list of products and services 214 if the items and services receive low ratings. The products and services 214 may be rated by consumers or users of the products and services. Consumers or users of the products and services are encouraged to, for example, supply their thoughts and experiences with the product or service. In another embodiment, the products and services may be rated by doctors. A doctor rating may include a video or voice or written statement. Furthermore, the doctors themselves may also be rated by the consumers.

Products that are not yet introduced into the product line 214 may be presented to existing consumers for a vote. If the potential product receives enough votes, for example, it may earn a place in the product line 214 and consumers may then add the product to their registry 102, 300 and/or purchase the new product.

With the products and services 214 rated and reviewed, an embodiment of the invention may give a consumer confidence that the selected products are indeed essential to, beneficial for and not in conflict with a current course of care, for example. Prior to purchasing any items 214, a consumer may have the option to send your cart to a healthcare provider (e.g., oncologist) for approval (e.g., approval of the product ingredients), ensuring that the products fit a specified treatment regimen. Once a consumer is ready to place a order, the consumer may check out online or the consumer may have the option to move some or all of the selected items to into a personal registry FIG. 3 300. Unlike current retailers, a consumer may not receive multiple shipments from various retailers. The items may be packed in (beautifully packaged) box or boxes, with one receipt. Multiple copies of the receipt may be provided for assisting with, for example, facilitating reimbursement tracking with insurers, tax-preparation, etc, saving valuable time and capturing what could inadvertently be unreported expenditures.

The registry 300, may allow a consumer to select items 214 wanted or needed and move them into the registry 102, 300 so that, for example, friends, family, church groups, co-workers, etc (i.e., third-parties) can select a gift that you want or make contributions toward your purchases. Once items are in the registry 102, 300, items 302 may be removed by pressing a button such as the “Remove Item” button 404. Items 302 in the registry 102, 300, may be purchased or added to a shopping cart by, for example, pressing the “Order Item” button 306.

The system may contain a list of specialists such as, certified mammography centers, licensed fitters (e.g., Board for Orthotics/Prosthetic Certification (BOC) or American Board for Certification in Orthotics & Prosthetics (ABC)), nutritionists, wig/prosthetic maker, etc. If a consumer requires a specialist, the consumer may select the specialist type and enter the consumer address (if not known already). Once the specialist type and consumer address is entered into the system a list and/or map of specialists in the consumer's area may be displayed. For example, the system may show the consumer a list of specialists within a specified number of miles (e.g., 5, 10, 20, 50, etc.). In one embodiment, specialists that are highly rated or have an agreement may be highlighted when displaying a list of specialists to the consumer. If the consumer selects a specialist, driving directions to the specialist may be displayed, again, adding to time savings.

The system may allow a specialist manager, for example, to upload a list of specialists, locations, and their areas of practice (could be multiple specialties per specialist) into a system's admin panel, for example. This may include the ability to add individual and for example, comma separated values, upload of locations. In one embodiment, a specialist or specialist group may submit a list of specialists, locations, and their areas of practice and may be considered for listing. After a period of due diligence, for example, the specialist may be added to the list for their related specialties.

For example, if a consumer requires a specialist (e.g., certified mammography center, licensed fitters, nutritionists, wig/prosthetic maker, etc.) the consumer may need information about the specialist, including directions, types of insurance carried, hours of operation, areas of specialty, etc. The consumer may be given a list of specialists in their area, such as by zip code, from which to choose. The consumer may rate their experience with the specialist and upload this into a rating database that may be accessed by other users of that good or service.

In one embodiment, contributor or contributors may have contributed $1,000 to a consumer for the purchase of a wig, for example. The consumer may use a debit card, for example, to pay for the wig and the $1,000 may be used for the purchase of the wig.

In one embodiment, a consumer may have been diagnosed with an illness. A consumer may be made more comfortable when third parties contribute 106 (e.g., financially, spiritually, time, etc.) towards products and services 214 that may assist in comforting the consumer. Furthermore, friends, family, co-workers, church groups, community foundations, contributors, etc, may feel better about the manner in which they contribute to a consumer when they can be assured that any and all contributions may go towards a dedicated purpose (e.g., healthcare). The system supplied registry 102, 300 and contributions module for website use may provide assurance that a contribution to the consumer is related to an intended purpose (e.g., healthcare, wellbeing, etc.).

The gift registration and contributions module may have, for example, multiple users. A first user may be a consumer, for example, who may create a gift registry 300 using the system and accept contributions towards it. Another user may be a third-party associate of the consumer (e.g., a friend, a co-worker, a family member, members of a religious community, members of a charitable organization, etc.) or other contributor who may purchase products or services from the registry 800 and/or may make a monetary contribution 900.

In one embodiment, the system outputs a comprehensive catalog of relevant products and services related to a consumer's need associated with a particular issue faced by the consumer at a particular stage which may be on-line or in print. The catalog, printed and/or on-line, may be customized for a particular healthcare entity (e.g., doctor's office, hospital, etc.) or the catalog may be customized to a target audience such as a men's catalog, youth catalog, Spanish catalog, etc. A kiosk may be provided to display the on-line catalog. The kiosk may have a telephone which may contact an individual associated with the system for instant consumer service. The kiosk may display instructional videos (e.g., how to measure) or product videos. The catalog, printed and/or on-line, may also be targeted for specific locations such as women's centers, breast cancer centers, support groups, gyms, plastic surgeons, trade shows, conferences, travel (e.g., skymall). The catalog, printed and/or on-line, may be co-branded the same as the center where it is located for revenue sharing or donation or contribution. Further customization may include specific doctor choices and recommendations, doctor/healthcare professional photos, commentary from the doctor or healthcare professional (e.g., articles on products or diseases, category introductions, editorials, etc.). The catalog may be placed into specialty magazines (e.g., Health Monitor). The printed catalog's ratings may match the on-line ratings at the time of printing. The printed catalog may offer links for instructional videos (e.g., how to take certain measurements, product information, etc). Postcards with product testimonials may also be used. Also, recorded video personal testimonials may also be used with service or product demonstrations or experiences. The personal testimonials may be videos of individuals telling their stories (e.g., Amy, a seven-year breast cancer survivor).

In another embodiment, in addition to the product ratings as described above, consumers of products and services may be measured or tracked for a period of time (e.g., daily, every three days, weekly, monthly, etc.). Measurements may include wellness, such as emotional, physical, fatigue, appetite, etc. The measurements may be tied to general wellness or specific clinical products for managing the collective feedback. Tracking could be provided for specific products and/or for clinical trials which may have specific monitoring questions. Measurements may be obtained from consumers using, for example, an e-commerce rating engine, a podcast, via email, etc. The measurements may then be given to the manufacturer of the products, the provider of the service, or clinical trial operator to help enhance the product, service, or trial.

In another embodiment, the registry and/or account management system may be integrated into healthcare systems (e.g., doctor's offices, hospitals, insurance companies, pharmacies, etc.). By integrating the registry into the backend of healthcare systems, purchased items or services may be redeemed on-site through the registry 102. For example, if co-pay was purchased through the registry 102, the healthcare provider may receive payment through the registry 102 and not directly from the consumer.

Although some of the above embodiments may be directed to breast cancer additional diseases or disorders may also be encompassed by embodiments of the invention. Additional diseases and disorders are addressed in the following paragraphs.

Prostate Cancer

Other than skin cancer, prostate cancer is the most common cancer in American men. The latest American Cancer Society estimates for prostate cancer in the United States are for 2010:
About 217,730 new cases of prostate cancer will be diagnosed.
About 32,050 men will die of prostate cancer.
1 man in 6 will be diagnosed with prostate cancer during his lifetime.
More than 2 million men in the United States have been diagnosed with prostate cancer at some point are still alive today.
Prostate cancer is the second leading cause of cancer death in American men, behind only lung cancer.
About 1 man in 36 will die of prostate cancer.

An embodiment of the invention may be tailored to individuals dealing with prostate cancer issues. Prostate cancer survivors may find post-operative prostatectomy or radical prostatectomy challenges such as the need for compression like under garments, catheter/wound site cleaning/maintenance creams/gels/lotions, specialty clamps for urine leakage/incontinence and impotence. These unique products (e.g., incontinence clamps) may be in addition to the products needed to complement radiation therapy or other doctor directed therapies. The nature of the disease may create certain sensitivities and warrant discretion in purchasing items or services, supporting individuals, and/or getting advice from others who have been through this life altering disease. Advice may include post-operative sexual well-being and nutritional advice. An embodiment of the invention may include an aggregation method, rating/review system, and quicklists which may dramatically improve a consumer's ability to find unique and niche products and to determine which products and services are right for them.

Arthritis

An embodiment of the invention may be tailored to individuals with arthritis. Arthritis is inflammation of one or more joints which results in pain, swelling, stiffness, and limited movement. There are more than 100 different types of arthritis. It can occur in men and women of all ages. About 37 million people in America have arthritis of some kind, which is almost 1 out of every 7 people. Most are chronic (e.g., long-term) conditions and the goal of treatment is to control the pain and minimize joint damage. Chronic arthritis frequently goes in and out of remission.

Osteoarthritis is the most common type and is more likely to occur as people age. It may be felt in any joint, but most commonly in hips, knees or fingers. In some autoimmune forms of arthritis, the joints may become deformed if the disease is not treated. Such joint deformities are the hallmarks of severe, untreated rheumatoid arthritis. Treatment of arthritis depends on the cause, which joints are affected, the severity, and how the condition affects the individual's daily activities. If possible, treatment will focus on eliminating the cause of the arthritis. In fact, making lifestyle changes without medications may be preferable for osteoarthritis and other forms of joint inflammation. If needed, medications may be used in addition to lifestyle changes.

In an embodiment of the invention, treatment categories may include exercise, joint support, rest and stress reduction, body positioning and mobility aids, and/or surgery and other interventions.

Exercise may be necessary to maintain healthy joints, relieve stiffness, reduce pain and fatigue, improve muscle and bone strength, and lose weight. An exercise program may be tailored to the individual and may include, for example, low-impact aerobic activity (also called endurance exercise), range of motion exercises for flexibility, and/or strength training for muscle tone.

An embodiment of the invention may include exercise products and services for arthritis. Products and services may include exercise videos, exercise equipment, mats, exercise bands, foam rollers, arthritis friendly weights, personal training services, personal trainer locators (e.g., via zip codes), physical therapy services, physical therapist locators (e.g., via zip codes), etc.

Joint support techniques may help support and correctly align joints. Joint support may be particularly necessary for rheumatoid arthritis. In addition to typical physical therapy, a physical therapist may also consider water therapy, ice massage, and/or transcutaneous nerve stimulation (TENS).

An embodiment of the invention may provide joint support products and services for arthritis. Products and services may include joint wraps, splints, hand and wrist supports, arthritis gloves, hot and cold mittens and foot wraps, heat wraps, compresses, carpal cuffs, splints, orthotics (e.g., service provider recommendation), capsaicin cream, heat spray, natural pain relief creams, therapeutic bathing salts, vitamins, minerals, nutritionists, cookbooks, glucosamine, chondroitin, and over-the-counter (OTC) anti-inflammatory medications such as Acetaminophen (Tylenol), NSAIDs (Aspirin, ibuprofen, or naproxen), etc.

Rest and stress reduction, (e.g., sleeping 8 to 10 hours per night and taking naps during the day) may help recovery from flare-up more quickly and may even help prevent exacerbations.

An embodiment of the invention may provide rest and stress reduction products and services for arthritis. Products and services may include neck support pillows, leg support pillows, bed wedges, body aligners, back support, nap mats, personal alarms, meditation, guided imagery, books, videos, services, Yoga, That Chi, etc.

Body positioning and mobility aids may assist in avoiding or recovering from an arthritic flare-up. Techniques may include avoiding holding one position for too long, avoiding positions or movements that place extra stress on affected joints, and/or making in-home activities easier.

An embodiment of the invention may provide body positioning and mobility products and services for arthritis. Products and services may include grab bars for the shower, tub, and near the toilet, cookware, tableware, dining utensils, kitchen openers, bathing aids, bathroom sitting and standing aids, grooming and hygiene aids, toileting aids, dressing aids, hair dryer stands, gardening tools, writing aids, big button TV remotes, grippers, adapters, holders, office aids, playing cards/holder, dressing aids, sitting, standing and walking aids, car mobility aids, gel cushions for sitting and standing, easy-to-use daily products, etc.

Surgery and other interventions may be required for individuals suffering from arthritis. In some cases, surgery to rebuild the joint (e.g., arthroplasty) or to replace the joint (e.g., a total joint replacement) may help maintain a more normal lifestyle.

An embodiment of the invention may provide products and services for arthritic suffers who have or are considering surgery or other interventions. Products and services may include previously-owned artificial joints, walkers, ice packs, compression stockings, hydration aids, incision coverings, foot and ankle pumps, toilet and shower supports, etc.
Autism, Autistic Spectrum Disorders (ASD), Pervasive Developmental Disorder-Not Otherwise Specified (PDD-NOS), Asperser Syndrome, Childhood Disintegrative Disorder (CDD) and Rett Syndrome

Estimates for autism include the following:
Autism effects 1 in every 100 children.
Autism effects 1 in every 54 boys.
40% of autistic children do not talk at all.
25%-30% of autistic children have some words at 12 to 18 months of age and then lose them.
The lifetime cost for an individual with autism is estimated to be $3.2 million.
Autism costs the nation over $35 billion per year, a figure expected to increase dramatically in the next decade.
There is currently no cure for autism.
No one knows what causes autism.
In 20 years there has been more than a 600% increase in diagnosed cases of autism

The National Institute of Child Health and Human Development (NICHHD) explains Autism Spectrum Disorder as follows: “Different people with autism can have very different symptoms. Health care providers think of autism as a ‘spectrum’ disorder, a group of disorders with similar features. One person may have mild symptoms, while another may have serious symptoms. But they both have an autism spectrum disorder.”

Additionally, some of the other names that fall under the definition of Autism Spectrum Disorder may include classic autism, Asperser's syndrome, PDD-NOS (pervasive developmental disorder, not otherwise specified), and atypical autism. The financial burden associated with those diagnosed with Autism Spectrum Disorder can be substantial, in fact over one's lifetime it is estimated to cost $3.2 million.

An embodiment of the invention may be tailored to individuals dealing with autism issues. From the assessment stage through adulthood, autism management is a never ending battle for those afflicted and their loved ones. Behavioral management, language, life and social skills often require special schools, special day/child care and increased medical expenses. Products may include, for example, safety proofing ones home, identification cards, and tracking kits. Additionally, sensitivity to textures and fabrics, difficulty with fasteners, and fit may require specialty clothing. Learning tools such as puzzles, workbooks, flash cards, software and expensive eye hand coordination devices can help parents aid in their child's development. Recently studies suggest revising one's dietary and nutritional intake as a promising trend in managing Autism Spectrum Disorders. Cookbooks, books, workbooks, journals, chore guides, routine oriented calendars, all help keep the family and child on track and are all out-of-pocket and often not covered by medical insurance. Specialists such as nutritionists, speech pathologists (40% of Autistic children do not speak at all), developmental pediatricians, behavioral therapists, physical therapists, life coaches and support groups for children and family members alike are disorganized and often come by “word of mouth.”

Family members are often concerned about their loved ones ability to survive after they are gone, therefore legal advice and preparation may be necessary, and costly. A variety of products may be needed to augment a healthcare professional's course of treatment. The overwhelming cost to support your loved ones may be substantial.

Care Plan

A business process step may include conducting a detailed personal care assessment from a financial, not necessarily medical perspective. The assessment identifies the needs of an individual (e.g., patient). Based on the assessment, appropriate and relevant recommendations may be determined. The recommendations may include products and services based on the assessment. In some cases the recommended products and services may be delivered or provided to the individual.

The assessment may present an individual with a broad range of questions to identify his/her healthcare, lifestyle/social, and/or financial needs. Based on the individual's responses, features and services relevant to the individual may be determined using industry standard benchmarks. The scope of offerings may be automatically narrowed to provide appropriate recommendations, information, and/or available financial resources.

The technology and business intelligence is provided to conduct the financial assessment. Existing industry best-practice models and/or industry domain expertise may be used to develop and present the assessment (e.g., the questions, workflow, and rules).

The assessment may determine the healthcare, lifestyle/social, and financial needs of an individual and their families. The results of the assessment may provide recommendations to individuals in two broad categories—(i) products/services and/or (ii) charitable gifts/government benefits.

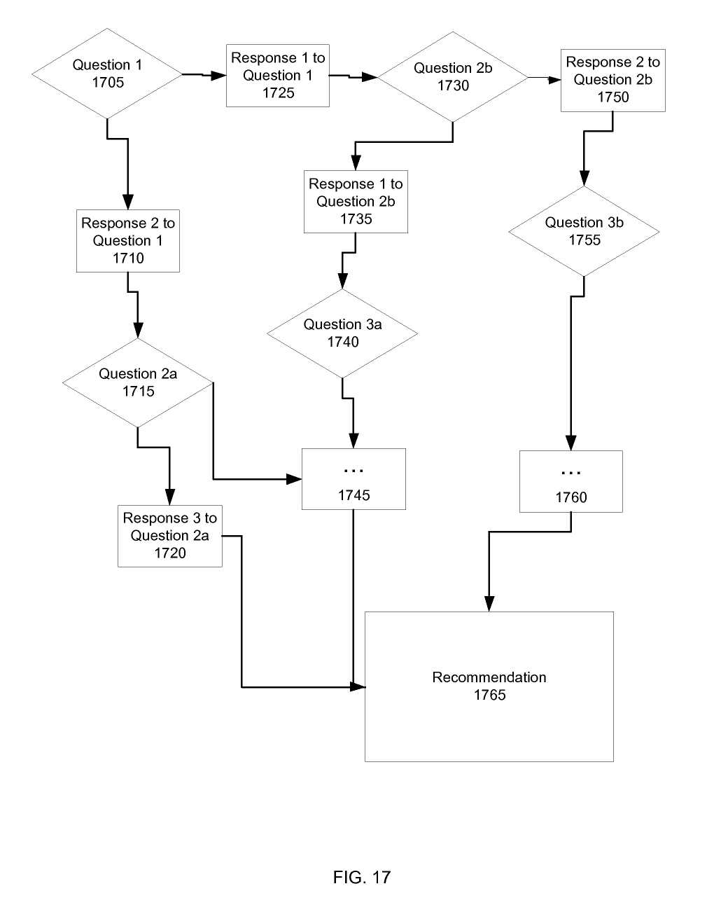

For example FIG. 17 depicts an illustrative workflow describing an example user assessment. A user may be presented with a dynamic assessment that may include questions that vary depending on the responses received. For example, FIG. 17, question 1 1705 may ask, for example, “What is your current income level?” Then, based on response 1725 or 1710, (e.g., less than $100,000 or more than $100,000, respectively) a rules engine may determine which questions to ask next (e.g., which question path), such as question 2a 1715 or question 2b 1730. Question 2a 1715 might ask, for example, “Do you need help getting to doctor's appointments?” If response 1720 included “no” the responses 1710 and 1720 (and others) may be fed into a recommendations engine to provide recommendation 1765 for the individual being assessed. Recommendation 1765 may include recommendations for products and/or services both financial and non-financial. Depending on the questions and responses, a similar pattern may be repeated. For example, response 1735 to question 2b 1730 may lead to question 3a 1740 which may continue through question and responses 1745 to recommendation 1765. Similarly, response 1750 may proceed to question 3b 1755 which may continue through question and responses 1745 and ultimately lead to recommendation 1765.

Through analysis of the assessment, tailored products, services and/or financial support channels may be identified and a personalized care plan may be generated that included relevant aspects (e.g., services). Recommendations from the Assessment may be populated into the care plan below. Friends and family members, for example, may sign up to handle the recommendations and/or may have the ability to create new recommendations within the plan.

The personalized care plan creates a team including individuals and groups (e.g., friends, family, co-workers, charity groups, medical professionals, employers, faith based support, patient navigators, insurance company representatives, and volunteers, government entities, etc.) and assigns various responsibilities to the team members. The goal of the team is to ensure that the care plan is executed.

Each member of the team may own or be responsible for various tasks on the plan (e.g., transportation, ordering products, preparing meals, providing mental support, coordinating third-party services and/or helping arrange day care, etc.). The care plan may assist in managing schedules, team collaboration (e.g., interact, chat, discuss, coordinate, etc.) and in organizing fundraisers.

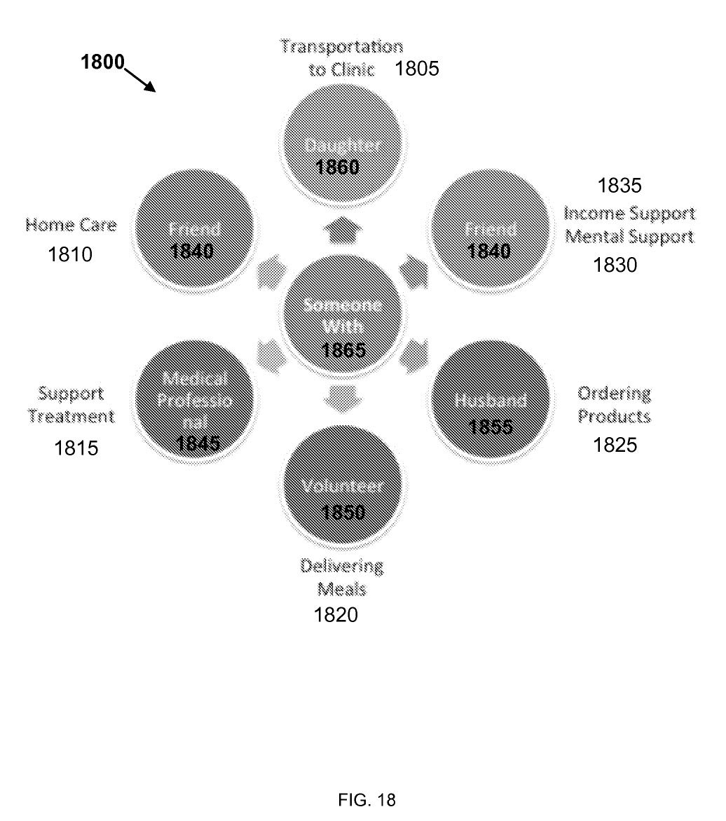

For example, FIG. 18 depicts illustrative care plan 1800 which may be created by a care plan engine based on recommendation 1765 (e.g., the output of the assessment as depicted in FIG. 17). A participant (e.g., a patient) 1865, may be at the center of care plan 1800 and may be the recipient of services (e.g., transportation 1805, home care 1810, support treatment 1815, delivering meals 1820, ordering products 1825, mental support 1830, and/or income support 1835, etc.) delivered by assignees (e.g., friend 1840, medical professional 1845, volunteer 1850, husband 1855 (e.g., spouse), and/or daughter 1860 (e.g., family member), etc.). For example, participant 1865 need transportation 1805 may be created and daughter 1835 may be assigned or could sign up to fulfill this need. Additional recommended services/needs to be addressed may also be populated as shown by income support 1835 mental support 1830 which has been allocated friend 1840 who may have signed up manually or been automatically assigned, for example. Additional needs to be addressed may include, for example, ordering products 1825, addressed by husband 1855, delivering meals 1820, addressed by volunteer 1850, support treatment 1815, addressed by medical professional 1845 and home care 1810 addressed by friend 1840. These are examples of potential needs and assignees and does not necessarily reflect the complete list that may be populated by a care plan engine to create care plan 1800.

### Illustrative Computer System

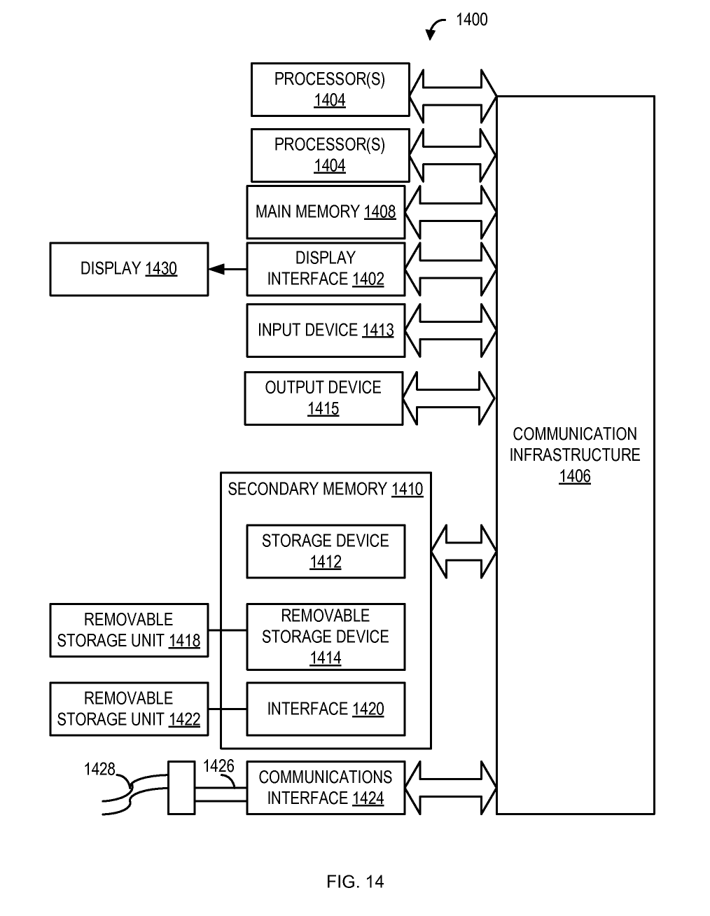

FIG. 14 depicts an illustrative computer system that may be used in implementing an illustrative embodiment of the present invention. Specifically, FIG. 14 depicts an illustrative embodiment of a computer system 1400 that may be used in computing devices such as, e.g., but not limited to, standalone or client or server devices. FIG. 14 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. For example, consumer account management system 520 may be implemented using one or more computer systems 1400. Additionally, webpage 200, registry page 300, registry page 800, contribution page 900, and checkout page 1100 may be implemented using one or more computer systems 1400. Also, care plan engine, recommendations engine, rules engine, and care plan 1800 may be implemented using one or more computer systems 1400.

An example of a computer system 1400 is shown in FIG. 14, depicting an illustrative embodiment of a block diagram of an illustrative computer system useful for implementing the present invention. Specifically, FIG. 14 illustrates an example computer 1400, which in an illustrative embodiment may be, e.g., (but not limited to) a personal computer (PC) system running an operating system such as, e.g., (but not limited to) MICROSOFT®WINDOWS° NT/98/2000/XP/Vista/Windows 7/etc. available from MICROSOFT® Corporation of Redmond, Wash., U.S.A. or an Apple computer executing MAC® OS from Apple® of Cupertine, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 1400 is shown in FIG. 14. Other components of the invention, such as, e.g., (but not limited to) a computing device, a communications device, a telephone, a personal digital assistant (PDA), an iPhone, iPad, a 3G wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 14. In an illustrative embodiment, services may be provided on demand using, e.g., an interactive television device (iTV), a video on demand system (VOD), via a digital video recorder (DVR), and/or other on demand viewing system.

The computer system 1400 may include one or more processors, such as, e.g., but not limited to, processor(s) 1404. The processor(s) 1404 may be connected to a communication infrastructure 1406 (e.g., but not limited to, a communications bus, cross-over bar, interconnect, or network, etc.). Processor 1404 may include any type of processor, microprocessor, or processing logic that may interpret and execute instructions (e.g., for example, a field programmable gate array (FPGA)). Processor 1404 may comprise a single device (e.g., for example, a single core) and/or a group of devices (e.g., multi-core). The processor 1404 may include logic configured to execute computer-executable instructions configured to implement one or more embodiments. The instructions may reside in main memory 1408 or secondary memory 1410. Processors 1404 may also include multiple independent cores, such as a dual-core processor or a multi-core processor. Processors 1404 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 1400 may include a display interface 1402 that may forward, e.g., but not limited to, graphics, text, and other data, etc., from the communication infrastructure 1406 (or from a frame buffer, etc., not shown) for display on the display unit 1430. Display unit 1430 may be, for example, a television, a computer monitor, or a mobile phone screen. The output may also be provided as sound through a speaker.

The computer system 1400 may also include, e.g., but is not limited to, a main memory 1408, random access memory (RAM), and a secondary memory 1410, etc. Main memory 1408, random access memory (RAM), and a secondary memory 1410, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 1410 may include, for example, (but is not limited to) a hard disk drive 1412 and/or a removable storage drive 1414, representing a floppy diskette drive, a magnetic tape drive, an optical disk drive, a compact disk drive CD-ROM, flash memory, etc. The removable storage drive 1414 may, e.g., but is not limited to, read from and/or write to a removable storage unit 1418 in a well known manner. Removable storage unit 1418, also called a program storage device or a computer program product, may represent, e.g., but is not limited to, a floppy disk, magnetic tape, optical disk, compact disk, etc. which may be read from and written to removable storage drive 1414. As will be appreciated, the removable storage unit 1418 may include a computer usable storage medium having stored therein computer software and/or data.

In alternative illustrative embodiments, secondary memory 1410 may include other similar devices for allowing computer programs or other instructions to be loaded into computer system 1400. Such devices may include, for example, a removable storage unit 1422 and an interface 1420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1422 and interfaces 1420, which may allow software and data to be transferred from the removable storage unit 1422 to computer system 1400.

Computer 1400 may also include an input device 1413 may include any mechanism or combination of mechanisms that may permit information to be input into computer system 1400 from, e.g., a user. Input device 1413 may include logic configured to receive information for computer system 1400 from, e.g. a user. Examples of input device 1413 may include, e.g., but not limited to, a mouse, pen-based pointing device, or other pointing device such as a digitizer, a touch sensitive display device, and/or a keyboard or other data entry device (none of which are labeled). Other input devices 1413 may include, e.g., but not limited to, a biometric input device, a video source, an audio source, a microphone, a web cam, a video camera, and/or other camera.

Computer 1400 may also include output devices 1415 which may include any mechanism or combination of mechanisms that may output information from computer system 1400. Output device 1415 may include logic configured to output information from computer system 1400. Embodiments of output device 1415 may include, e.g., but not limited to, display 1430, and display interface 1402, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 1400 may include input/output (I/O) devices such as, e.g., (but not limited to) communications interface 1424, cable 1428 and communications path 1426, etc. These devices may include, e.g., but are not limited to, a network interface card, and/or modems.

Communications interface 1424 may allow software and data to be transferred between computer system 1400 and external devices.

In this document, the terms “computer program medium” and “computer readable medium” may be used to generally refer to media such as, e.g., but not limited to, removable storage drive 1414, a hard disk installed in hard disk drive 1412, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to computer system 1400. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

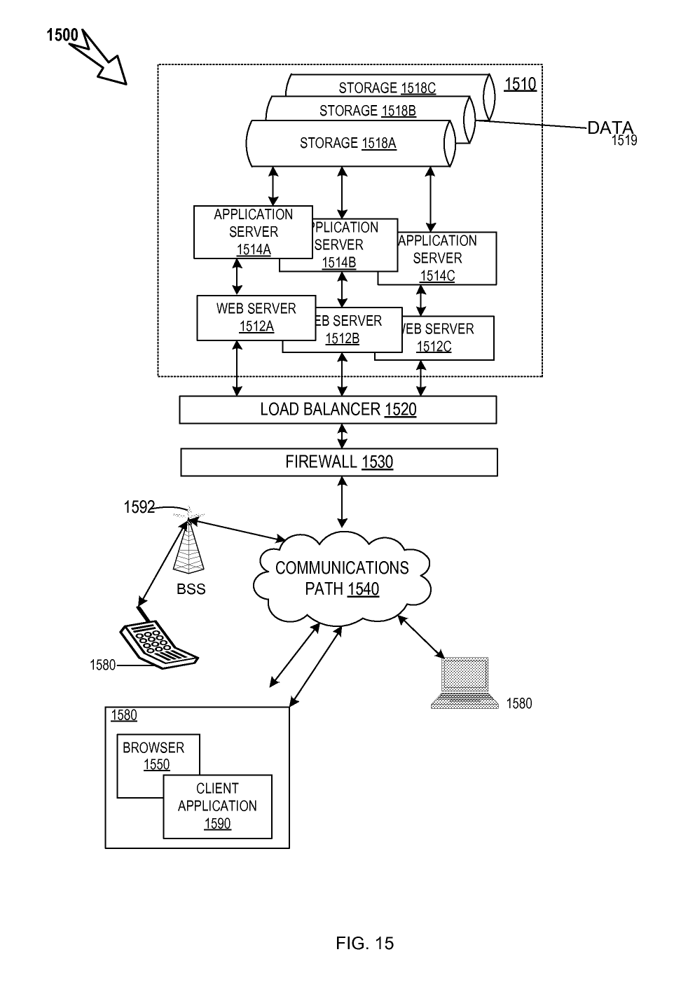

FIG. 15 depicts an example high-level view of an illustrative embodiment of a workflow storage and distribution system 1500 according to an illustrative embodiment of the present invention. The workflow communication and/or computing device 1510 may create, store, transmit, and receive electronic transmissions. The workflow communication and/or computing device 1510 may provide data storage for multiple workflows and context information. Workflow communication and/or computing device 1510 may also allow for data transactions to and from various client devices 1580. The workflow communication and/or computing device 1510 and the client devices 1580 may be a computing device 1400 or any other device capable of interacting with communications path 1540. The client devices 1580 may be mobile devices that may wirelessly transmit data and voice information with the base station subsystem (BSS) 1592. The BSS 1592 may be responsible for handling traffic and signaling between a mobile device 1580 and the communication path 1540.

The physical or logical storage unit 1518 may, for example, store workflow data, sample queries, text or video, photographs, audio, text, marketing information, product information, and client data. The servers 1512 and 1514 may be coupled to client devices 1400 through a communications path 1540 (e.g., but not limited to, the Internet) via a load balancer 1520 and a firewall 1530. According to another embodiment (not shown), the distribution system 1500 could be represented by any of a number of well known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) could also be used.

The client devices 1580 may be equipped with a dedicated workflow application 1590 that may provide the workflow functionality described in the paragraphs above. Alternatively, client devices 1580 may contain a browser 1550 (e.g., but not limited to, Internet Explorer, Firefox, Opera, etc.), which may, in conjunction with web server 1512, provide the same functionality as the dedicated workflow application 1590.

Various embodiments of this invention may use workflow storage and distribution system 1500 and/or multiple instances of computer 1400 and may be implemented as a computing cloud if desired (e.g., a cloud computing environment).

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application. It may also be part of a healthcare provider's system (e.g., a hospital, doctor's office, etc.).

FIG. 15 depicts an example high-level view of an illustrative embodiment of a workflow storage and distribution system 1500 according to an illustrative embodiment of the present invention. The workflow communication and/or computing device 1510 may create, store, transmit, and receive electronic transmissions. The workflow communication and/or computing device 1510 may provide data storage for multiple workflows and context information. Workflow communication and/or computing device 1510 may also allow for data transactions to and from various client devices 1580. The workflow communication and/or computing device 1510 and the client devices 1580 may be a computing device 1400 or any other device capable of interacting with communications path 1540. The client devices 1580 may be mobile devices that may wirelessly transmit data and voice information with a base station subsystem (BSS) 1592. The BSS 1592 may be responsible for handling traffic and signaling between a mobile device 1580 and the communication path 1540.

The physical or logical storage unit 1518 may, for example, store workflow data 1519, queries, product and services ratings, text or video, photographs, audio, text, marketing information, product information, and client data. The stored data 1519 may be stored and used for data mining purposes to calculate, for example, marketing trends over time and efficacy of products and services. The servers 1512 and 1514 may be coupled to client devices 1400 through a communications path 1540 (e.g., but not limited to, the Internet) via a load balancer 1520 and a firewall 1530.

According to another embodiment (not shown), the distribution system 1500 could be represented by any of a number of well-known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) could also be used.

The client devices 1580 may be equipped with a dedicated workflow application 1590 that may provide the workflow functionality described in the paragraphs above. Alternatively, client devices 1580 may contain a browser 1550 (e.g., but not limited to, Internet Explorer, Firefox, Opera, etc.), which may, in conjunction with web server 1512, provide the same functionality as the dedicated workflow application 1590

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

The technology described above may scale to support numerous consumers, benefactors, and vendors, including dozens, hundreds, and/or millions. This system permits managing of large scale consumer accounts and data transactions that would not be possible without the use of computer system 1400 and/or workflow storage and distribution system 1500.

What is claimed is:

1. A computer-implemented method of managing payment of healthcare related items, the method comprising:
creating, by a computer, a consumer account for a consumer, wherein the consumer account is managed by a consumer account management system;
receiving, by the computer, a contribution to the consumer account from a benefactor, wherein the benefactor is a friend, acquaintance, or family member of the consumer, a non-profit organization, or a corporation wherein the contribution is not associated with insurance of the consumer;
applying, by the computer, rules designating as approved for purchase one or more specialty items relevant to a particular disease or disorder at a given stage or treatment cycle of the disease or disorder, wherein the one or more specialty items are associated with one or more vendor systems, wherein the one or more vendor systems are integrated with the consumer account management system or are third-party vendor systems;
crediting, by the computer, the contribution to the consumer account;
receiving, by the computer, data on a sales transaction for the one or more specialty items; and
storing, by the computer, relational data regarding the consumer and sales transactions.

2. The method of claim 1, wherein the one or more specialty items comprises at least one of a product or a service.

3. The method of claim 1, further comprising:
consolidating data from multiple consumers, wherein the data from multiple consumers comprises at least one of demographic information, disease state information, annual income information, geographic information, or item preference information.

4. The method of claim 1, wherein storing the relational data comprises limiting access to the stored data or storing data in compliance with governmental privacy regulations.

5. The method of claim 1, wherein the benefactor comprises at least one of a friend, a co-worker, a family member, a charitable institution, a religious entity, a manufacturer, a retailer, or a marketing agency.

6. The method of claim 1, wherein the contribution comprises at least one of: a coupon, cash, or a financial deposit.

7. The method of claim 1, wherein the data on the sales transaction comprises at least one of:
a merchant category code (MCC), an item code, a stock-keeping unit (SKU), a universal product code (UPC), a standard industrial classification (SIC), a North American industry classification system (NAICS), or a global industry classification standard (GICS).

8. The method of claim 1, further comprising:
restricting purchase of an item based on the rules from the benefactor, wherein the rules from the benefactor comprise an allocation of benefactor supplied funds to benefactor selected items.

9. The method of claim 1, further comprising:
receiving financial data from a manager of the financial account, wherein the financial data from a manager comprises at least one of: transaction information, account balance information, or contribution information;
receiving warehouse data comprising at least one of: inventory turns information, cycle time information, lead time information, or cost of goods sold information; or
receiving vendor system data comprising at least one of: claims utilization information, patient responsibility information, store information, item information, payment information, rejected payment information, or spending statistics.

10. A non-transitory computer-readable storage media for storing computer-executable instructions executable by processing logic, the media storing one or more instructions for:
creating a consumer account associated with a consumer;
adding a consumer-selected item to the consumer account;
receiving funds directed to the consumer account from a benefactor, wherein the benefactor includes at least one of: a friend, a family member, a charity, a manufacturer, or a third-party;
associating the funds with rules from the benefactor, wherein the rules designate categories of items that may be purchased;
receiving purchase data of an item in accordance with the rules from the benefactor, wherein purchase data comprises data on at least one of: items purchased or items rejected for non-compliance with the rules from the benefactor; and
consolidating purchase data across multiple retail outlets.

11. The non-transitory computer-readable storage media of claim 10, further comprising:
associating the consumer account with a secure on-line registry, wherein the consumer account is managed by a consumer account management system associated with an inventory tracking system; and
receiving a selection of an item from a catalog of items relevant to a stage of a disease or disorder, wherein the item is associated with a vendor system, wherein the vendor system is integrated with the consumer account management system or is a third-party vendor system.

12. The non-transitory computer-readable storage media of claim 10, wherein the benefactor is not the consumer, a government agency, or an insurance provider.

13. A consumer account management system comprising:
a consumer account creation module for creating a consumer account associated with a consumer;
a contribution receiving module for receiving a contribution directed to the consumer account from a benefactor and crediting the contribution to the consumer account, wherein the benefactor is a friend, acquaintance, or family member of the consumer, a non-profit organization, or a corporation wherein the contribution is not associated with insurance of the consumer;
a benefactor rules module for associating the contribution with rules from the benefactor, wherein the rules designate as approved for purchase one or more specialty items relevant to a particular disease or disorder at a given stage or treatment cycle of the disease or disorder;
a purchase data receiving module for receiving purchase data of the one or more specialty items, wherein the items were purchased by the consumer in accordance to the rules from the benefactor; and
a database for storing data on at least one of: purchases, the one or more specialty items, consumers, and sales transactions.

14. The system of claim 13, further comprising:
a vendor integration module for integrating a vendor system with the consumer account management system, wherein the one or more specialty items are associated with the vendor system;
an inventory tracking system for tracking the one or more specialty items associated with the vendor system; and
a data consolidation module for consolidating data from multiple consumers.

15. The system of claim 14, wherein the vendor system is integrated with the consumer account management system or is a third-party vendor system; and
wherein, the vendor integration module prohibits the purchase of an item in non-compliance with the benefactor rules.

16. The system of claim 13, wherein the database stores at least one of:
account data comprising at least one of: transaction information, account balance information, or contribution information;
multiple consumer data comprising at least one of: demographic information, disease state information, annual income information, geographic information, or item preference information;
warehouse data comprising at least one of: inventory turns information, cycle time information, lead time information, or cost of goods sold information; or
vendor system data comprising at least one of: claims utilization information, patient responsibility information, store information, item information, or spending statistics.

17. The system of claim 13, wherein the purchase data of an item comprises at least one of:
a merchant category code (MCC), an item code, a stock-keeping unit (SKU), a universal product code (UPC), a standard industrial classification (SIC), a North American industry classification system (NAICS), or a global industry classification standard (GICS).

18. A computer-implemented method for establishing a digital health care currency, comprising
establishing a consumer account by a computer;
crediting, by the computer, contributions of amounts of digital currency to the account from a benefactor, wherein each amount of digital currency is associated with rules designating particular approved categories of specialty items relevant to a health condition of the consumer, the rules being set by the benefactor, wherein the benefactor is a friend, acquaintance, or family member of the consumer, a non-profit organization, or a corporation wherein the contribution is not associated with insurance of the consumer;
debiting, by the computer, digital currency from the account for purchases of items in the approved categories by the consumer;
monitoring, by the computer, digital currency credits and debits; and
reporting, by the computer, digital currency credits and debits

19. The method of claim 18, further comprising establishing numerous consumer accounts in the computer, the consumer account for each consumer being associated with specialty items relevant to a health condition of the consumer.

20. The method of claim 19, further comprising, for each consumer account, tracking the amount and kind of currency credited to that account, and the currency debited from the account, along with associated data selected from designations of particular items, types of items, or vendors of items for which the currency may be spent.

21. The method of claim 18, wherein the digital currency is money, coupons, or in-kind donations.

22. The method of claim 18, further comprising crediting digital currency provided by friends or family of the consumer or non-profit or for profit organizations other than insurance companies.

23. The method of claim 22, further comprising accepting digital currency provided by at least one of government agencies, insurance companies, or the consumer.

24. The method of claim 22, further comprising matching the rules for each type of currency with purchase choices by the consumer, the rules allowing for currency to be debited from the account if it is designated for a particular purchase, and the rules rejecting debiting the account if the purchase is not in a designated category.

25. The method of claim 18, wherein the rules permit purchasing any product or service relevant to the health condition of the consumer in a catalog from a particular vendor.

26. The method of claim 18, wherein the rules permit payment for purchasing prescription drugs or co-pays or fees associated with medical procedures.

27. The method of claim 18, further comprising crediting the account with non-designated currency.
